(19) United States
(12) Patent Application Publication
(10) Pub. No.: US 2010/0204867 A1
(43) Pub. Date: Aug. 12, 2010

(54) COLLISION AVOIDANCE SYSTEM AND METHOD

(75) Inventor: Dennis LONGSTAFF, West End (AU)

Correspondence Address: MCGUIREWOODS, LLP, 1750 TYSONS BLVD, SUITE 1800, MCLEAN, VA, 22102, US

(73) Assignee: Teledyne Australia PTY LTD, Eight Mile Plains (AU)

(21) Appl. No.: 12/611,660

(22) Filed: Nov. 3, 2009

Related U.S. Application Data
(63) Continuation of application No. PCT/AU2008/000628, filed on May 2, 2008.

(30) Foreign Application Priority Data
May 4, 2007 (AU) 2007902404

(51) Int. Cl. G01S 13/93; G05D 1/00

(52) U.S. Cl. 701/26

(57) ABSTRACT

A collision avoidance system for use with an unmanned vehicle, the system includes a plurality of radar elements arranged parallel to the longitudinal axis of the unmanned vehicle, wherein the radar elements transmit a plurality of pulses about the vehicle and receive a plurality of return signals from one or more objects within the range of the vehicle. Upon detecting the one or more objects within range of the vehicle, the system determines if an object is on a course which requires evasive action and suitably alters the vehicle's course in order to avoid collision.

### CROSS REFERENCE TO PRIOR APPLICATIONS

This application is a continuation of International Application PCT/AU2008/000628, published as WO 2008/134815, with an international filing date of May 2, 2008, which claims priority from Australian Patent Application No. 2007/902404, filed May 4, 2007, all of which are hereby incorporated by reference for all purposes as if fully set forth herein.

### BACKGROUND OF THE INVENTION

1. Field of the Invention

The present invention relates to a collision avoidance system and method. In particular although not exclusively the present invention relates to a collision avoidance system for unmanned air vehicles or the like.

2. Discussion of the Background Art

Collision avoidance systems have been employed in a wide variety of applications ranging from simple range detection, similar to that used in parking sensors employed in most high-end automobiles, to more sophisticated applications such as aircraft mid air warning systems.

One example of such a collision avoidance system is the Traffic Collision Avoidance System (TACS) which is employed in most passenger aircraft. Under TACS each aircraft is fitted with a transponder. Each aircraft transponder then interrogates all other aircraft transponders within a certain range, each transponder within range transmits the relevant position information to the interrogating unit. Through this active integration TACS is able to build a 3D map of aircraft within a given airspace including such information as airspeed, bearing and altitude.

The system then extrapolates the current position data to determine if the risk of a potential collision exists. Once a collision threat has been identified TACS then automatically negotiates a mutual avoidance manoeuvre between the two aircraft. The negotiated manoeuvre is then communicated to the flight crew for execution.

Another example of a collision avoidance system is the Portable Collision Avoidance System (PACS). Unlike TACS, PACS is a passive system where an interrogation signal is sent out from a ground based radar station. The transponder of any aircraft within range of the signal replies with their squawk code and altitude code. Any aircraft reply within the detection window of a PACS unit will be received. The unit computes the range, decodes the altitude information and then determines the angle of arrival for each aircraft in the detection window.

The altitude of the aircraft within the detection window is then compared with the local altitude of the unit. The relative altitude each aircraft in the detection window is then calculated. The unit then displays the relative direction altitude and range calculated for each aircraft in the detection window to the pilot, with the top threat displayed on the left of the traffic screen. The top threat is determined by comparing the vertical separation (±relative altitude), and the range to each aircraft within the detection window.

Private aircraft operating outside designated air corridors are not required to carry TACS or PACS transponders, placing responsibility for collision avoidance on the pilot. The level of safety provided by visual “see and avoid” has been accepted even though the visibility from a cockpit is limited. Since transponders are not mandated in free airspace it is essential for unmanned air vehicles to have an autonomous “see and avoid” system with a capability at least as effective as a pilot.

As can be seen from the above discussion both transponder systems rely on the pilot of the aircraft to take the appropriate action to avoid collision, such systems are not readily suited to use in unmanned air vehicles and the like. In addition to this the laws governing the use of unmanned air vehicles or other vehicles in various applications typically require a higher safety margin than that of the collision system currently in use for manned vehicles.

Accordingly there is a need for a collision avoidance system for unmanned vehicles that can automatically effect course correction upon detecting a collision threat which at least meets and/or exceeds the mandated safety margins.

### SUMMARY OF THE INVENTION

### Disclosure of the Invention

Accordingly in one aspect of the present invention there is provided a radar array for use with an unmanned vehicle, said array including a plurality of antenna elements arranged parallel to the longitudinal axis of the unmanned vehicle wherein one or more of said antenna elements transmit a plurality of pulses about said vehicle and the remaining antenna elements receive a plurality of return signals from one or more objects within range of said vehicle.

In a further aspect of the present invention there is provided a radar array for use with an unmanned vehicle said array including plurality of transmitter elements for transmitting a plurality of pulses about said vehicle, a plurality of receiver elements for receiving a plurality of return signals from one or more objects within range of said vehicle and wherein the transmitter and receiver elements are arranged parallel to the longitudinal axis of the vehicle.

In another aspect of the present invention there is provided a radar pod for an unmanned vehicle, the radar pod being arranged parallel to the longitudinal axis of the unmanned vehicle, said pod including:
a plurality of transmitter elements;
a plurality of receiver elements for receiving a plurality of return signals from one or more objects within range of said unmanned vehicle; and
at least one processor coupled to the transmitter and receiver elements for controlling the transmission of a plurality of pulses from said transmitters, and wherein said processor being adapted to generate from said return signals a plurality of conical beams.

In another aspect of the present invention there is provided a radar pod, said pod including:
a plurality of transmitter elements;
a plurality of receiver elements for receiving a plurality of return signals from one or more objects within range of the radar pod; and
at least one processor coupled to the transmitter and receiver elements for controlling the transmission of a plurality of pulses from said transmitters, and said processor being adapted to generate from said return signals a plurality of conical beams.

In a further aspect of the present invention there is provided a collision avoidance system for an unmanned vehicle said system including:
a plurality of transmitter elements;
a plurality of receiver elements for receiving a plurality of return signals from one or more objects within range of said unmanned vehicle; and
at least one processor coupled to the transmitter and receiver elements said processor being adapted to:
transmit from said plurality of transmitters a set of pulses about the unmanned vehicle;
generate from said return signals a plurality of conical beams covering a volume of interest about said unmanned vehicle;
analysing one or more signal within the plurality of conical beams to determine if one or more objects within range of the unmanned vehicle are on a collision path; and
alter the course of the unmanned vehicle on determining that at least one object of the one or more objects is on a collision path with said unmanned vehicle.

In yet another aspect of the present invention there is provided a collision avoidance system for an unmanned vehicle, said system including:
a plurality of antenna elements arranged parallel to the longitudinal axis of the unmanned vehicle;
at least one processor coupled to the plurality antenna elements said processor being adapted to:
transmit from one or more of the antenna elements a set of pulses about the unmanned vehicle;
generate a plurality of conical beams covering a volume of interest about the vehicle from a plurality of return signals received by the remaining antenna elements from one or more objects within range of the unmanned vehicle;
analysing one or more signal within the plurality of conical beams to determine if one or more objects within range of the unmanned vehicle are on a collision path; and
alter the course of the unmanned vehicle on determining that at least one object of the one or more objects is on a collision path with said unmanned vehicle.

In yet another aspect of the present invention there is provided a method of avoiding a collision for an unmanned vehicle said method including:
transmitting a plurality of pulses about the unmanned vehicle;
receiving a plurality of return signals from one or more object in range of the vehicle;
generating from said return signals a plurality of conical beams covering a volume of interest about the unmanned vehicle;
analysing one or more signal within the plurality of conical beams to determine if one or more objects within range of the unmanned vehicle are on a collision path; and
altering the course of the unmanned vehicle on determining that at least one object of the one or more objects is on a collision path with said unmanned vehicle.

In a still further aspect of the present invention there is provided a method of avoiding a collision for an unmanned vehicle said method including:
transmitting, from a plurality of transmitters, a plurality of pulses about the unmanned vehicle;
receiving by a plurality of transmitters a plurality of return signals from one or more object in range of the vehicle;
generating from said return signals a plurality of conical beams covering a volume of interest about the unmanned vehicle;
analysing one or more signal within the plurality of conical beams to determine if one or more objects within range of the unmanned vehicle are on a collision path; and
altering the course of the unmanned vehicle on determining that at least one object of the one or more objects is on a collision path with said unmanned vehicle.

Preferably the plurality of transmitted pulses are transmitted as a set of omni-directional pulses which fill the space within a given range about the vehicle. It will be appreciated that the range covered by the pulses is a dependent upon a number of factors such as signal power etc.

Suitably the plurality transmitted pulses, each have a different signature code allowing the receiving elements to separate out return signals for each transmitting element reflected by one or more objects within range. Preferably each signature code is a carrier frequency selected from a set of predetermined frequencies. Alternatively each signature code could be a sequence of binary phase coded pulses.

In one form of the invention the transmitters may transmit the plurality of pulses utilising time division multiplexing (TDM), wherein the time delay between successive transmitted pulses is of sufficient length to allow the separate reception of return signals reflected by one or more objects within range.

Alternatively the transmitter elements may transmit the plurality of pulses utilising code division multiplexing scheme, whereby each transmitter simultaneously transmits at the same frequency a coded pulse wherein each pulse is coded with differing, preferably orthogonal, phase or amplitude modulations.

In yet another form of the invention the pulses may be transmitted in accordance with a frequency division multiplexing (FDM) scheme, wherein the carrier frequencies of the pulses are cycled incrementally after each transmission period, such that each transmitter element transmits a full set of pulses covering all the predetermined frequencies. Most preferably the pulses are transmitted in accordance with an orthogonal frequency division multiplexing (OFDM) scheme.

Preferably the number of frequency cycles L is equal to or greater than number of transmitter elements N. Suitably the transmission of the pulses is staggered, i.e. during the transmission each transmitter element transmits a different carrier frequency within the sequence of pulses to that of the adjacent transmitter element/s.

Where a frequency division multiplexing scheme is utilised to transmit the pulses, a constant frequency separation is employed between the carrier frequencies of each pulses (i.e. the spacing between the carrier frequencies of each pulse in the frequency domain is identical). Preferably a variety of pulse compression techniques such as step-frequency range compression can be employed to further improve range resolution. The sequence of frequencies so transmitted can be ordered according to certain codes to minimise the effect of Doppler on pulse compression. An example of such an ordered code set is that of Costas codes which set the hopping sequence for the frequency steps and improves the range/Doppler ambiguity

In another aspect of the invention the received signals by the plurality of receivers are fed to a signal processing system. The received signals may then be processed to form a set of conical beams filling the airspace within range and aligned with their axis common to the longitudinal axis of the vehicle. The conical beams may then be analysed by the processing system to determine if one or more objects within range are on a constant bearing. The received signals can be processed to measure the closing velocity by tracking the Doppler shift over time in order to determine a collision threat. For example a constant closing velocity may indicate a collision warning, while a suitably reducing velocity may indicate a safe passing track.

The generation of the conical beams may involve the use of coherent MIMO processing. Generation of the conical beams may be performed by first time shifting the signals received from all transmitter-to-receiver pair combinations such that they align in time if they arrive from a particular angle corresponding to one of the conical beams. By summing the signals so aligned the signal returns from a particular cone angle will be re-enforced to facilitate detection and association with the particular cone angle.

Alternatively, for a non-MIMO solution, a single omni-directional transmitter antenna is used then the linear array of receivers can form the conical beams in the conventional manner by applying linear phase shifts and summing.

Preferably the antenna elements are a combination of transmitter antennas and receiver antennas. In the case where the antenna elements are utilised to form the plurality of conical beams, each transmitter element is configured to transmit a complete set of pulses. Suitably the transmitter and receiver elements are dipole antennas. Alternatively the transmitter and receiver elements may be slot or patch antennas disposed around the outer periphery of the pod. Preferably the transmitter and receiver elements are configured to operate in the L, S, C, X, Kᵤ, K, or Kₐ bands.

The processor may be coupled to the transmitter and receiver elements via a plurality of multiplexers. Preferably each multiplexer services a multiplicity of antenna elements but at least a single transmitter and at least two receiver elements.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 is a schematic diagram depicting the geometry of a collision;

FIG. 2 is a schematic diagram depicting one spatial arrangement of the transmitter and receiver elements according of an embodiment of the present invention;

FIG. 3 is a block circuit diagram of one possible arrangement of the transmitter and receiver elements according to an embodiment of the present invention;

FIGS. 4A to 4I are models of the upper hemisphere of synthesised beams according to one embodiment of the present invention, covering all angles from end-fire through broadside to end fire in the opposite direction;

FIGS. 5A to 5C are plots of the array patterns for particular synthesised beams plotted as cuts through the cones according to one embodiment of the present invention;

FIG. 6 is a schematic diagram of the array of an embodiment of the invention as employed in on unmanned aircraft;

FIG. 7A is a beam trace diagram for an embodiment of the present invention wherein the transmitter and receiver elements are aligned with the axis of travel of the platform to which the elements are mounted;

FIG. 7B is a beam trace diagram for an embodiment of the present invention wherein the transmitter and receiver elements are offset to the axis of travel of the platform to which the elements are mounted;

FIG. 8 is an example of a Frequency Modulated Interrupted Continuous Wave (FWICW) MIMO waveform according to one embodiment of the present invention;

FIG. 9 is a plot of a first cut analysis for the detection range for the FMICW MIMO waveform of FIG. 8;

FIG. 10 is an example of a Pulse Doppler MIMO waveform according to one embodiment of the present invention;

FIG. 11 is a plot of a first cut analysis for the detection range for the Pulse Doppler waveform of FIG. 10;

FIG. 12 is a schematic diagram of one spatial arrangement of the transmitter and receiver elements according of an embodiment of the present invention;

FIG. 13 is a schematic diagram of one spatial arrangement of the transmitter elements according of an embodiment of the present invention;

FIG. 14 shows an example of a feed network of a transmitter array of a turnstile arrangement according to one embodiment of the invention

FIG. 15A-15B are plots of range sidelobes and cross channel leakage of the radar system according to an embodiment of the invention

FIG. 16 is a schematic diagram depicting a set of transmitter code sequences according to one embodiment of the invention;

FIG. 17 is a clutter map according to one embodiment of the invention;

FIG. 18 is a clutter map according to one embodiment of the invention;

FIG. 19 is a schematic diagram depicting the geometry of a collision; and

FIG. 20 is a flow diagram depicting a collision avoidance process according to one embodiment of the invention.

### DESCRIPTION OF EMBODIMENTS OF THE INVENTION

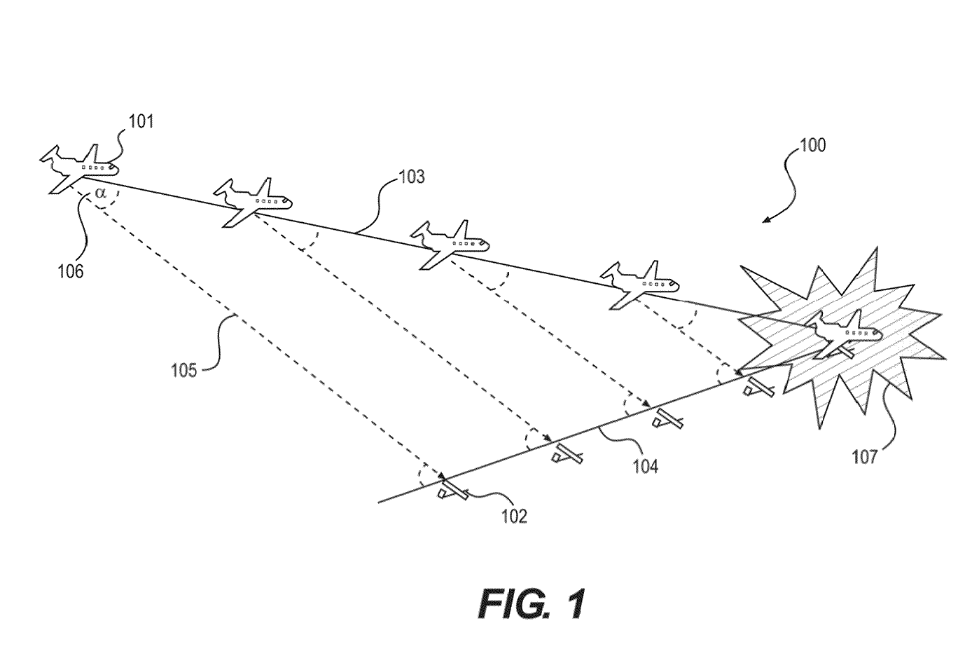

FIG. 1 depicts the basic geometry of a collision 100 between two vehicles. In this instance a first aircraft 101 on a first flight path 103 and a second unmanned aircraft 102 on a second flight path 104. The line of sight between each aircraft remains constant as does the relative angle α 106. As the aircraft continue along their respective flight paths the range 105 between the two is reduced at a constant rate and it is this constant reduction in range or constant relative angle α 106 that indicates a potential collision threat 107. Thus in order to avoid the collision 107 one of the aircraft 102 needs to alter course (i.e. change the relative angle α 106 between the two). However the aircraft cannot just simply alter tact, any course correction must be negotiated in accordance with the rules for a given airspace.

As discussed above, one of the factors inhibiting development and usage of unmanned vehicles is the lack of a collision avoidance system that provides such vehicles with the ability to intelligently change course to avoid a collision threat 107.

To this end the applicant has devised a system that is capable, amongst other uses, of being utilised as a collision avoidance system for unmanned vehicle, which is discussed in greater detail below. In addition this system has potential to be used in various military applications such as a missile approach warning system for fighter aircraft or for civil aircraft not fitted with transponder systems.

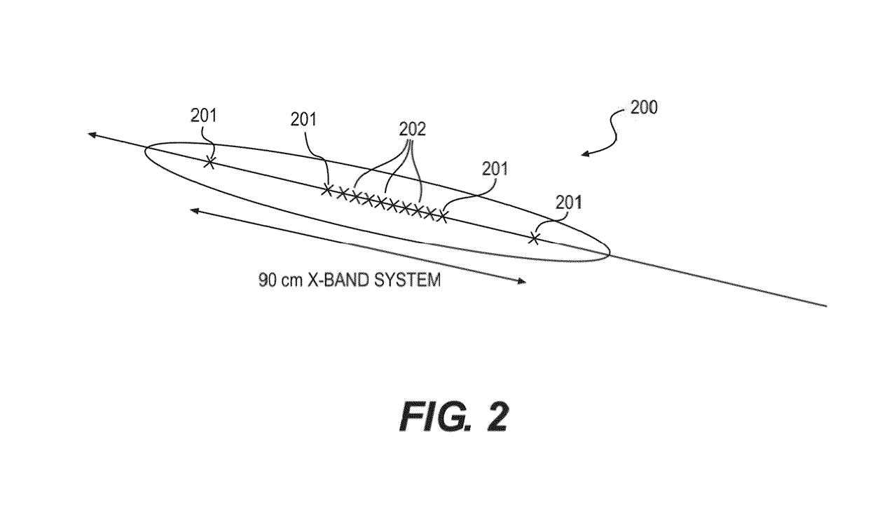

With reference to FIG. 2 there is illustrated one possible arrangement of a transmitter receiver array 200 which can be employed in system of the present invention. Here the transmitter elements 201 and receiver elements 202 are arranged in a staring line configuration which is mounted parallel to the longitudinal axis 203 of the vehicle. In this example the transmitter 201 and receiver elements 202 are cross-polarised dipoles configured for operation in the X band. This particular X band array has a total length of approximately 90 cm allowing the array to be easily mounted on the any portion of vehicle's body. For instance the array could be readily mounted to the fuselage, wing, wing tip or fin of a UAV, alternatively in the case where the vehicle is an unmanned land vehicle the array could be fitted to a wheel arch, hood or bumper.

Cross-polarised dipoles have been illustrated here because single dipoles are insensitive to signals arriving from an angle in line with the dipole. By switching between crossed dipoles on alternate pulses signals from all angels of arrival will be seen. While dipoles have been illustrated it will be appreciated by those of ordinary skill in the art that other antenna forms with near omni-directional cover are suitable, such as a magnetic loop antenna.

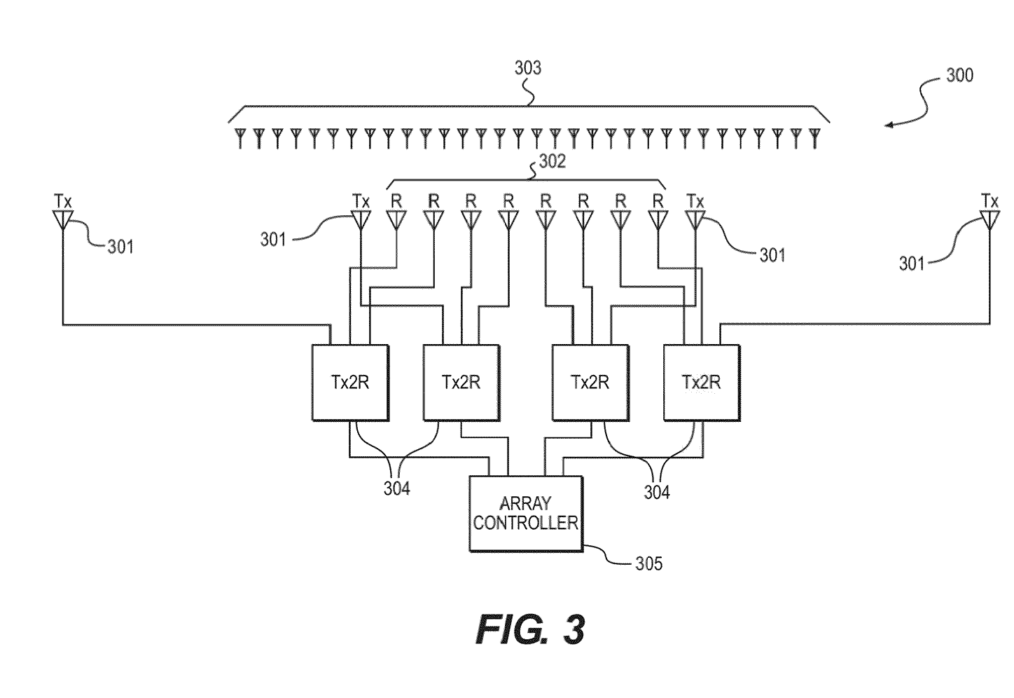

FIG. 3 shows one possible configuration of a linear MIMO array 300 for use in the system of the present invention. The use of the MIMO process to generate one or more transient elements 303 is discussed in the applicant's earlier filed international application PCT/AU2007/000033 which is herein incorporated by reference. The MIMO technique is extremely advantageous as it allows the applicant to minimise the number of elements required for a given number of radar beams.

As can be seen from FIG. 3 the linear MIMO array employs a transmitter 301 and receiver 302 arrangement similar to that discussed above in relation to FIG. 2. Each transmitter element 301 is paired with two receiver elements 303 via signal multiplexers 304 which are in turn coupled to an array controller 305

As discussed in the applicant's earlier work the process of generating transient elements makes use of the fact that the signal received from the far field with a bi-static transmitter receiver pair is identical to the signal which would be received by a single mono-static transceiver element placed at the mid point between the bi-static pair.

Under the MIMO approach the generation of synthetic elements involves transmitting a plurality of signal pulses in accordance with an orthogonal coding scheme whereby the signals received can be separated into the components from each separate transmitter antenna. An example of such orthogonal coding is frequency division multiplexing (FDM). With FDM, the carrier frequencies of the pulses are cycled incrementally after each transmission period such that each transmitter element transmits a full set of pulses covering all the transmitted frequencies. In the case of the array shown in FIG. 3 the array controller is configured to transmit a set of pluses having carrier frequencies [f₁,f₂,f₃,f₄] where f₁ is transmitted on the first transmitter T₁ and f₂ to f₄ are transmitted on the second through fourth transmitter T₂ to T₄ respectively.

The pulses are then cycled by the controller such that each transmitter transmits the full set of frequencies. For example after the first burst f₂ is then transmitted on T₁, f₃ on T₂, f₄ on T₃ and f₁ transmitted on T₄. This ensures that each of the receiver elements capture M×N time sequences where M is the number of receiver antenna elements and N is the number of receiver elements, in this case being equal to the number of transmitter frequency steps. Cycling the frequencies in this manner allows for the array of FIG. 3 to synthesise 32 transceiver elements.

Thus the linear MIMO array of FIG. 3 provides 32 conical beams which are co-axial with the longitudinal axis of the vehicle. This yields nominally 360°×360° range of coverage about the vehicle to which the array is mounted, but modified by the antenna element patterns.

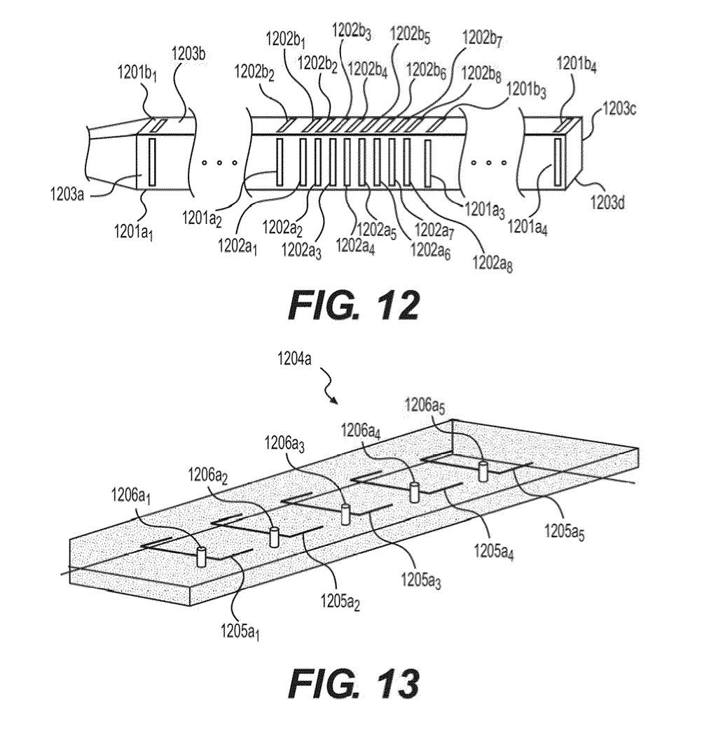

It will be appreciated, however, by those of ordinary skill in the art that given the relative small size of each X band transmit/receive element (typically only a couple of centimeters, it would also be possible to provide a nominal 360°×360° range of coverage by physically mounting 32 transceiver elements in a linear array parallel to the longitudinal axis of the vehicle. An example of one such physical array is discussed in greater detail in relation to FIG. 12 below. In such an instance the controller is configured to transmit the complete set of pulses on each of the transceiver elements. For each transmission the phases of the transmitter signals would be arranged in a slope across the array to form a single conical transmitter beam. By changing the phase slope from pulse to pulse a sequence of such conical transmitter beams can be formed, each at a different angle. The same phase slope can be applied to the received signals such that receiver beams are formed coincident with the transmitter beams, giving good angular discrimination with the entire sequence providing the desired all-round cover.

An alternative is to use a single omni-directional transmitter element and only use phase slopes across the receiver signals to form conical beams. This does however reduce the directivity of the array somewhat. An alternative approach to forming conical beams with the single omni-directional transmitter antenna and the linear array of receivers is to apply linear phase shifts and then sum the resulting signals.

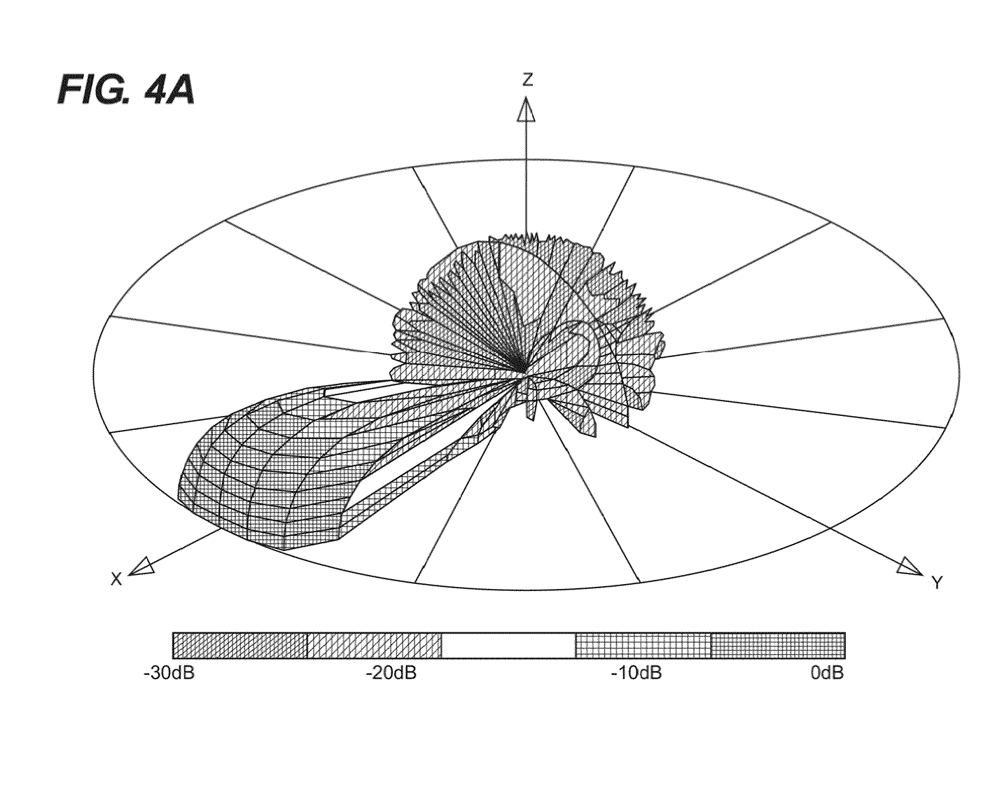

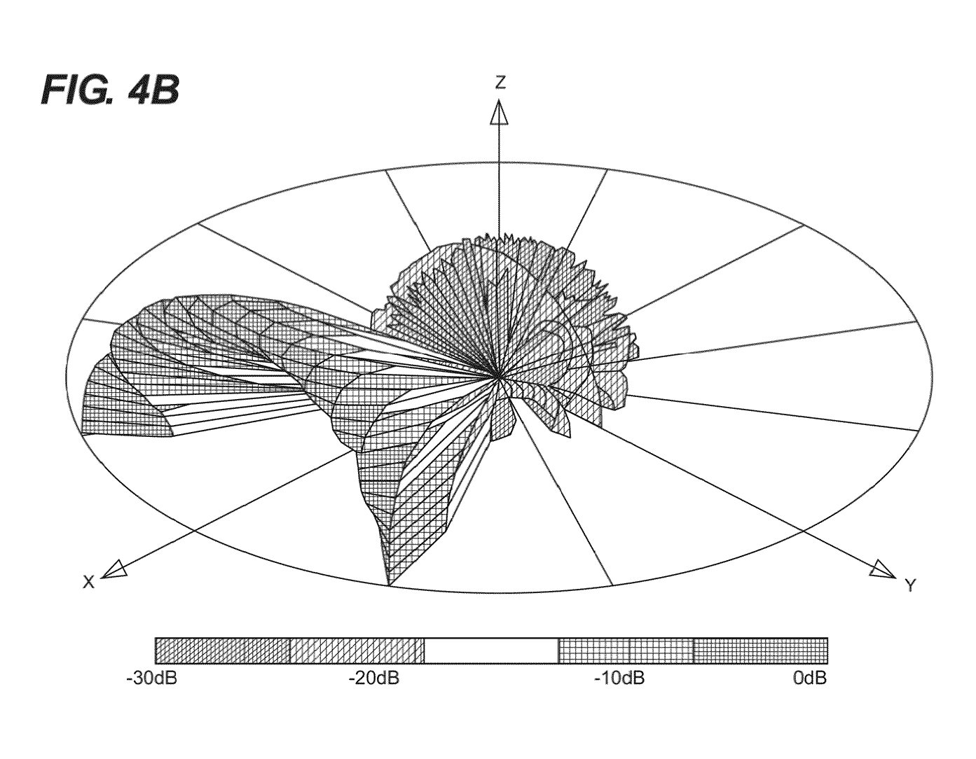

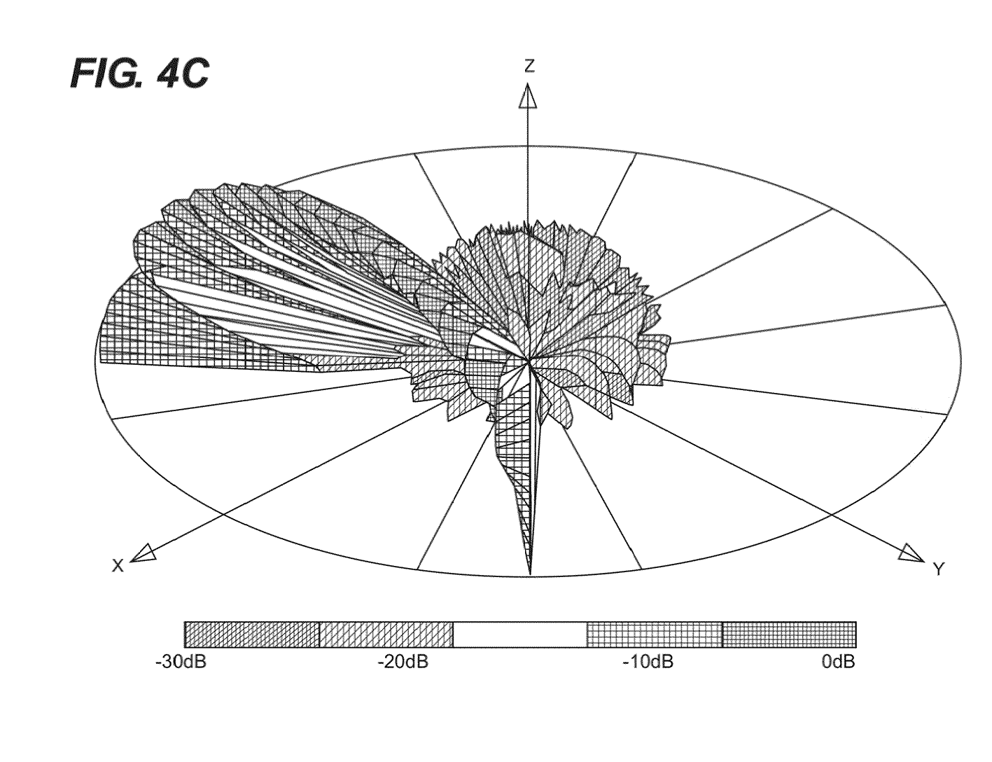

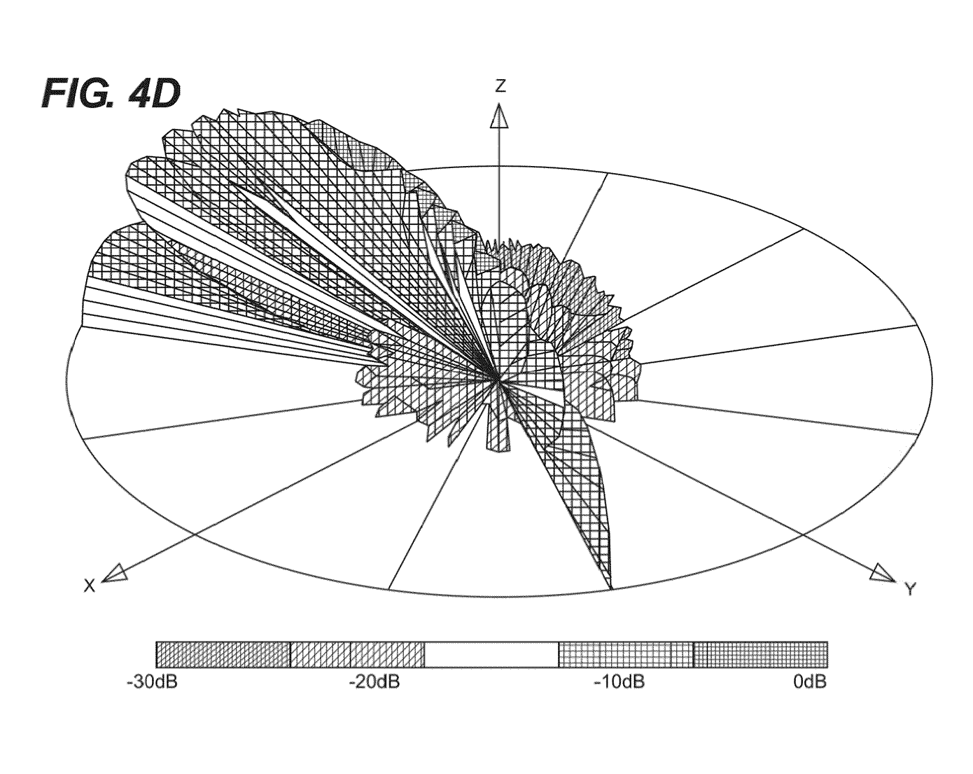

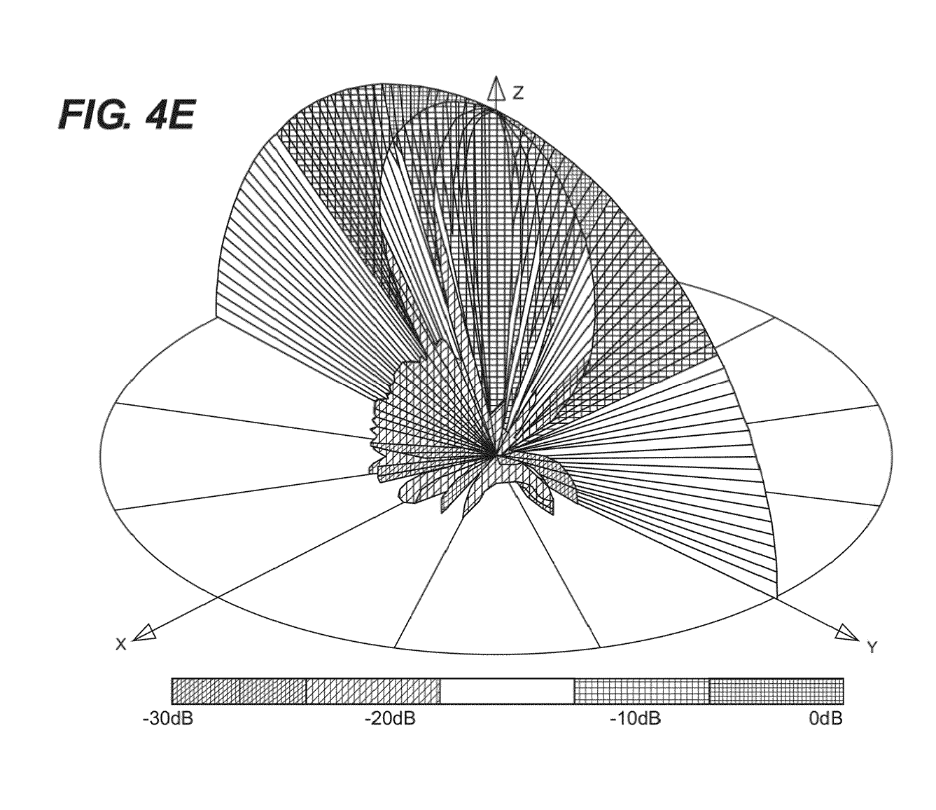

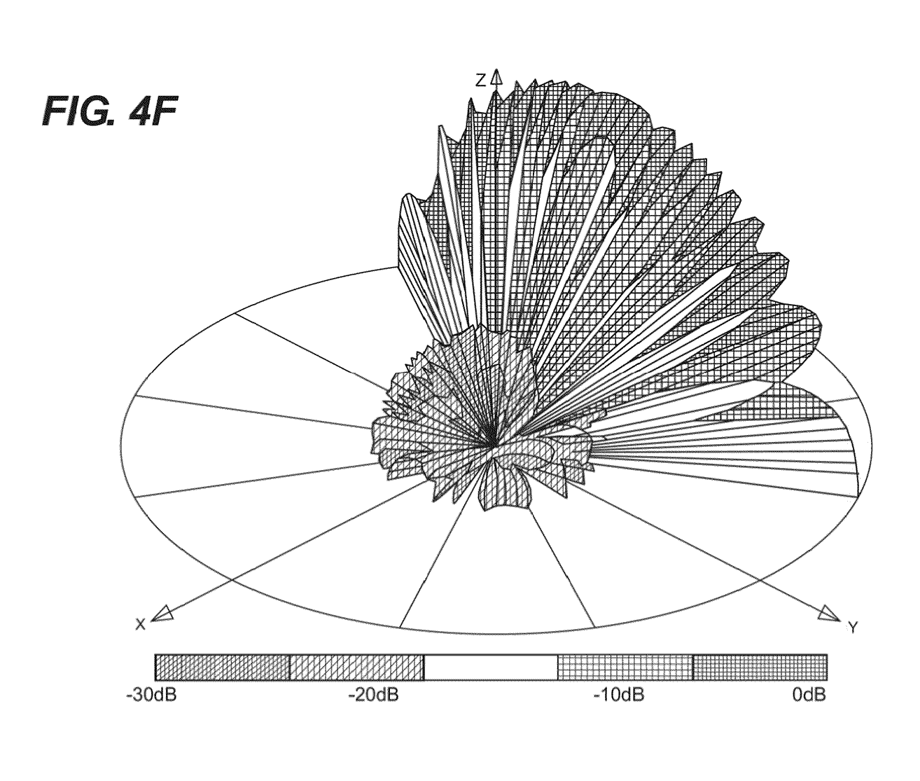

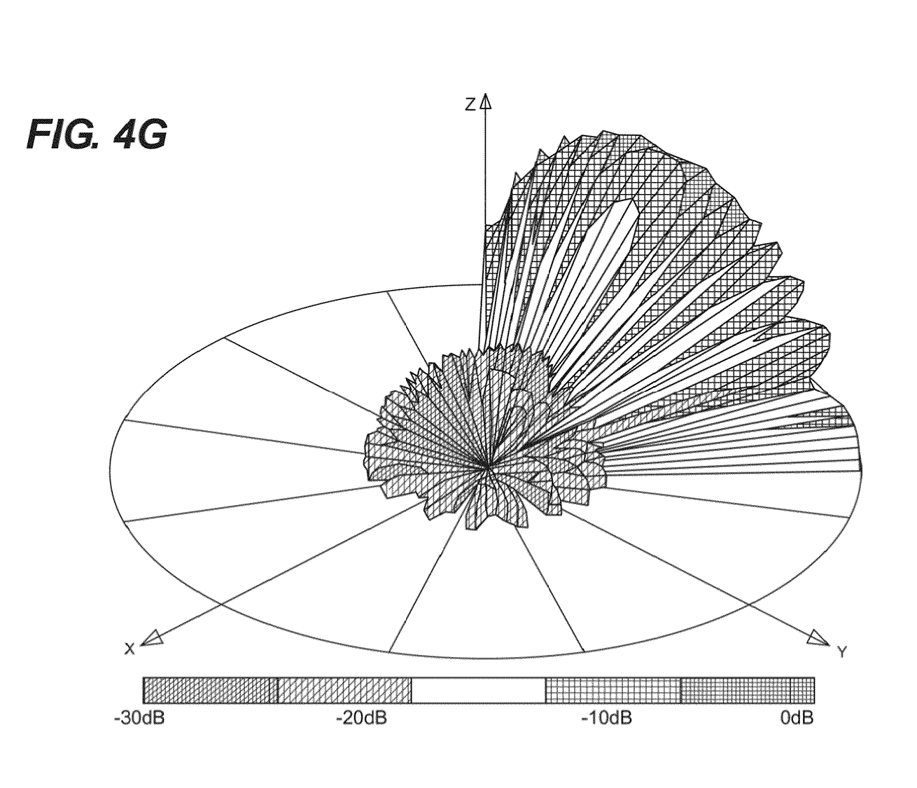

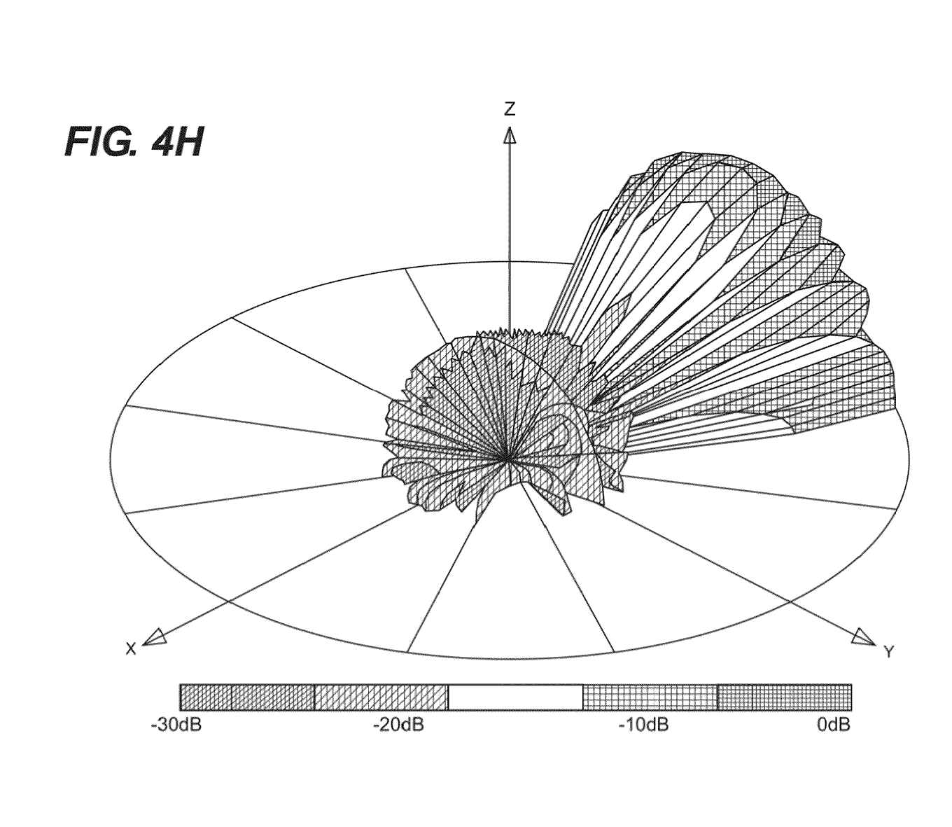

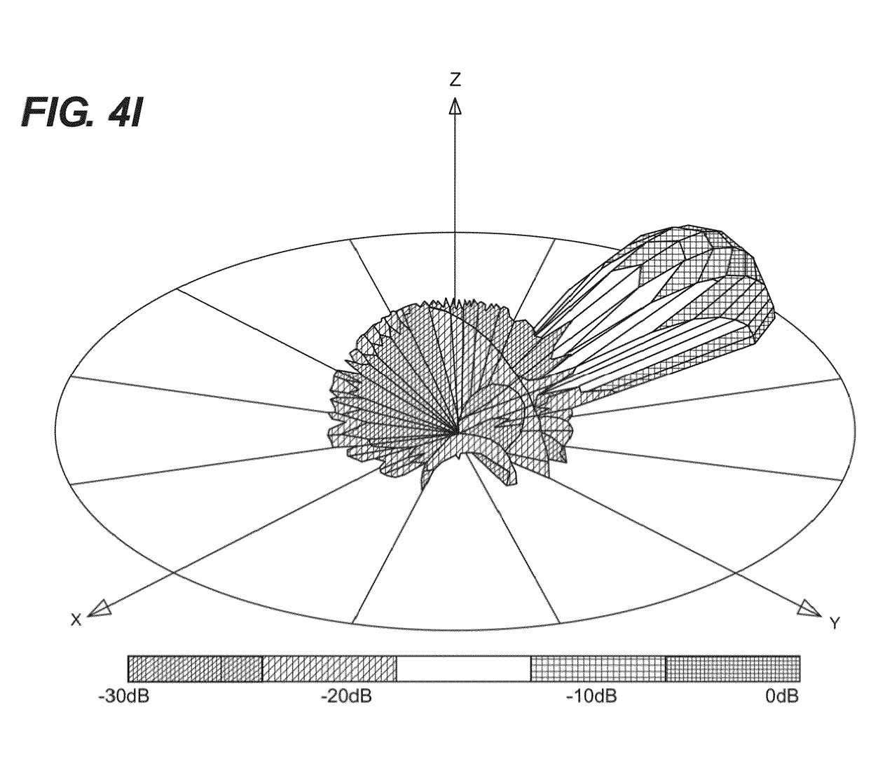

A plot of a selection the synthesised array patterns as they are swept from end fire through broadside to end fire is shown in FIGS. 4A to 4I. FIG. 4A depicts the fore end fire while 4I depicts the aft end fire. FIGS. 4B and 4H show the fore and aft 45° look respectively, while FIGS. 4C and 4G depict the fore and aft 60° look and FIGS. 4D and 4F show the 120° look and finally FIG. 4E shows the broadside pattern.

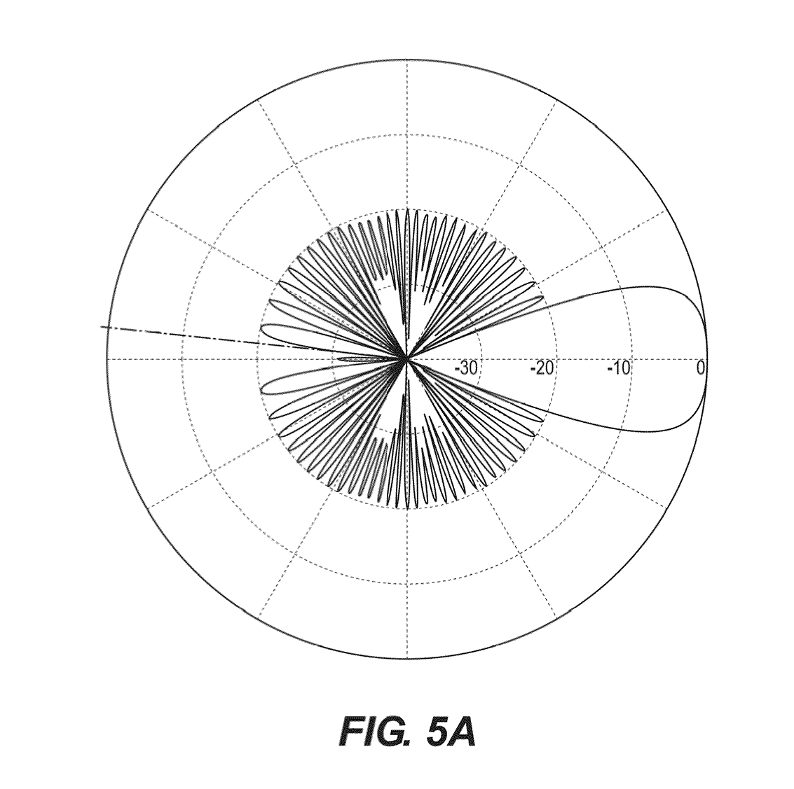

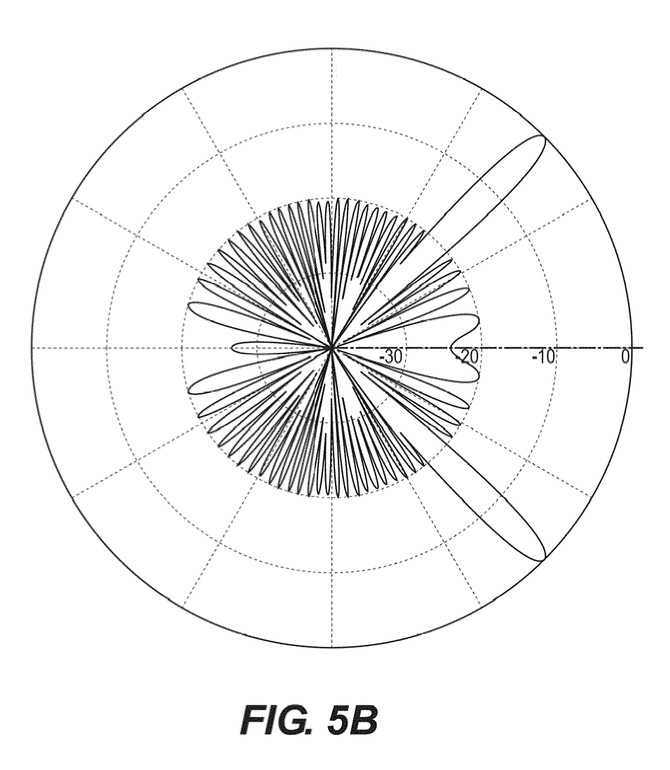

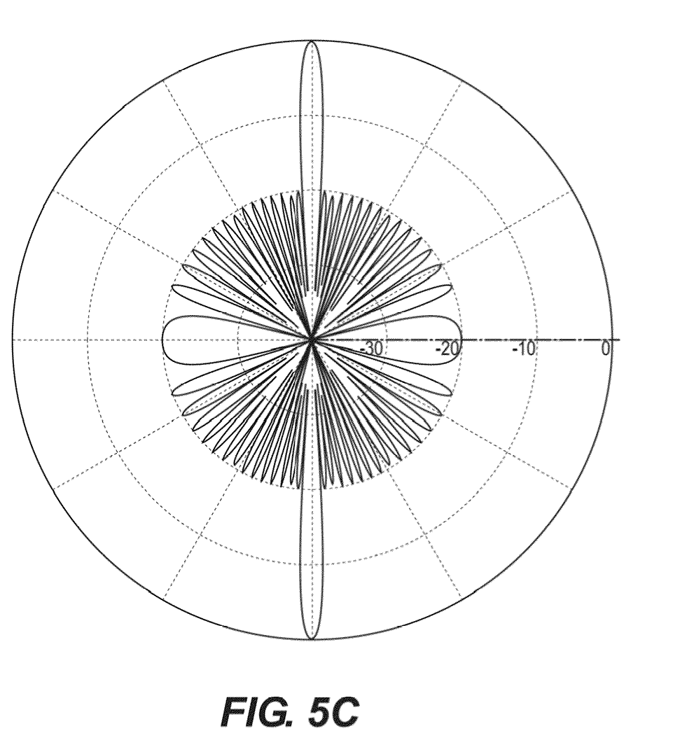

Similarly FIGS. 5A to 5C are plots of the array pattern where 5A is a plot of the end fire pattern, 5B a plot of the 45° look and 5C the broadside pattern.

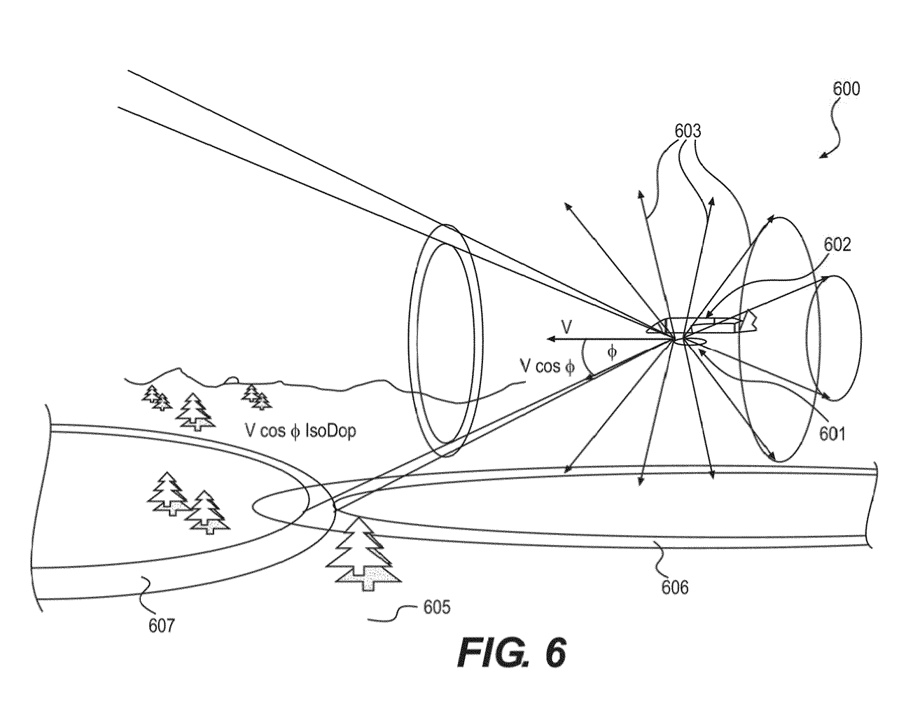

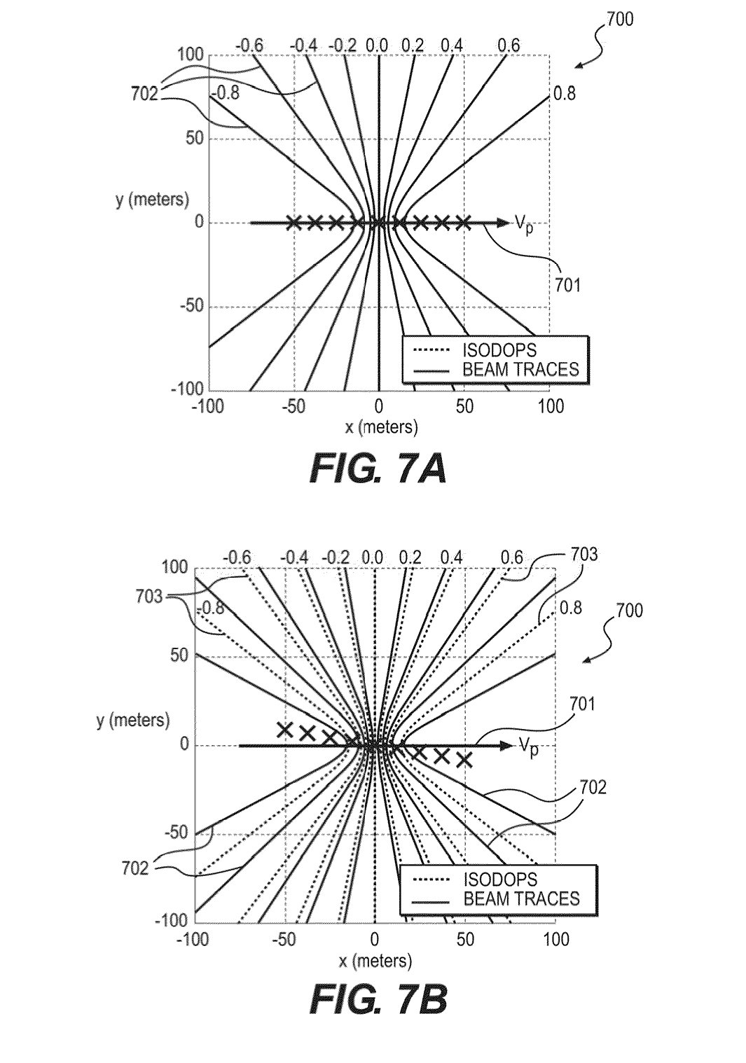

FIG. 6 depicts one possible application 600 of the array of FIG. 3. The array in this case is mounted within a pod 601 which is fitted to an unmanned vehicle. In this particular example the unmanned vehicle is an unmanned air vehicle (UAV) 602. As discussed above the array forms 32 conical beams 603 spanning fore to aft. The waveforms required to capture the Doppler spectrum and to form the 32 beams can be transmitted over a period of typically 25 ms. The waveforms can then be repeated continually or intermittently at for example 100 ms intervals to save transmitter power. This process completely envelops the UAV (i.e. 360°×360° of coverage). The portion of each of the conical beams, given by V cos φ, that intersects the ground 605 illuminates a hyperbolic arc producing iso-range ring 606. One principal advantage in utilising conical beams is that the iso-Doppler contours (lines of constant Doppler shift) 607 defined by V cos φ substantially overlap with the range ring contours 606 as shown. As the beam intercept the ground it substantially aligns with iso-Doppler contours this ensures that the main beam clutter is narrow-band and essentially on a different Doppler from a collision path target. This overlap between the iso-Doppler and the main beam is further illustrated in FIGS. 7A and 7B.

As can be seen from FIG. 7A utilising the conical beams in combination with a staring line array aligned along the axis of travel the 701 the beam traces 702 and iso-Dopplers 703 align. FIG. 7B shows the situation where the antenna is pushed out of alignment with the axis of travel 701 i.e. the UAV has begun to crab slightly due to a cross wind etc. In this case the beam traces 702 and iso-Dopplers 703 do not fully overlap, this mismatch however can be readily accounted for through filtering and most preferably adaptive filtering.

Thus the antenna pattern in this instance assists with clutter suppression and side lobe clutter can be controlled through Doppler filtering. In addition to the above the use of conical beams in combination with the staring line array provides for continuous illumination for a constant bearing target and allows for long integration time and high Doppler resolution for the target. The limited power aperture product further reduces the clutter problem, minimising range and Doppler ambiguities.

As discussed above due to the systems geometry a collision path target is essentially on a different Doppler than main-beam clutter. Thus a target on a collision bearing can be readily identified by the system and the flight path of the UAV altered accordingly. To further improve the accuracy of determining whether a target is on a collision course with the UAV the system may also perform an amplitude comparison. In such a comparison the relative signal amplitudes in two adjacent and partially overlapping beams is monitored, if the ratio remains constant then the target is on a constant bearing.

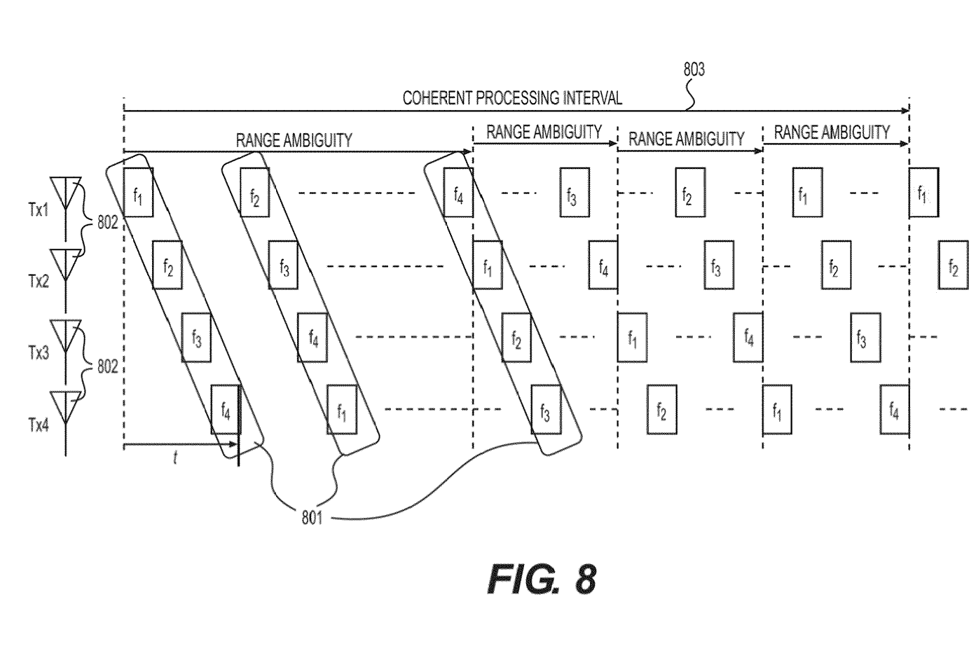

At present the collision avoidance system discussed above may be implemented as either an Interrupted Continuous Wave (ICW) system or as pulse Doppler system. One example of the waveform 800 for a Frequency Modulated Interrupted Continuous Wave (FWICW) MIMO system is shown in FIG. 8. As illustrated the set of pulses 601 is transmitted in accordance with a FDM scheme. The carrier frequencies [f₁, f₂, f₃, f₄] of the pulses within the set being cycled incrementally after each transmission period t, such that each transmitter element 802 transmits a full set of pulses 801 i.e. each transmitter transmits the set of frequencies [f₁, f₂,f₃, f₄]. In this case the coherent processing interval 803 is given by the number of transmission periods required to completely cycle the frequencies in order [f₁,f₂,f₃,f₄] through each of the transmitters 802. The advantage of the FMICW MIMO waveform is that it provides an unambiguous Doppler space which keeps a target clear of main beam clutter.

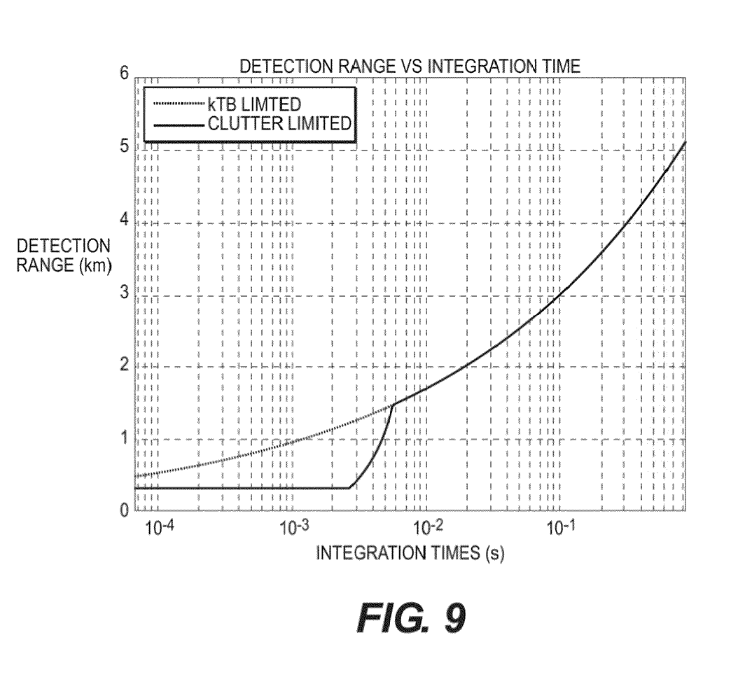

FIG. 9 shows a plot of a first cut analysis for the detection range of a FMICW MIMO waveform. The analysis was performed based on the following parameters and conditions:

| Radar Parameters | Conditions |
|---|---|
| PRF = 150 kHz | Ground reflectivity, γ = 0.1 |
| Pulse duration = 1.67 msec | Height = 300 m |
| Mean power = 1 Watt | 300 m/sec relative closing velocity |
| Wavelength = 3 cm. | 10 dB single-look detection threshold |
| Intrinsic range res. = 250 m | |

As can be seen from FIG. 9 the array remains virtually clutter free until R=300 m.

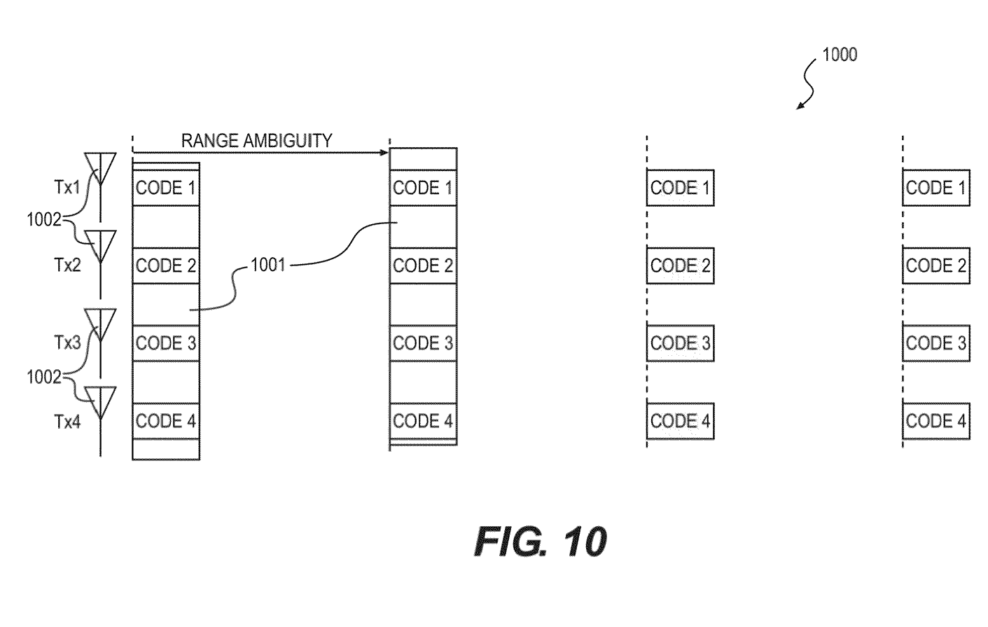

FIG. 10 depicts one example of the pulse Doppler MIMO waveform 1000 utilising a Code Division Multiplexing (CDM) scheme. In this case a set of 4 orthogonally coded pulses 1001 are transmitted from transmitters 1002, each pulse is coded with differing phase or amplitude modulations. This allows for a full radar image to be captured after a single pulse. Pulse compression is also available via code autocorrelation with a compression ratio of 100:1 and a duty cycle of 10:1 being possible. The CDM waveform also offers a fine range resolution (e.g. approximately 50 m) and short range ambiguity which may allow for unambiguous Doppler.

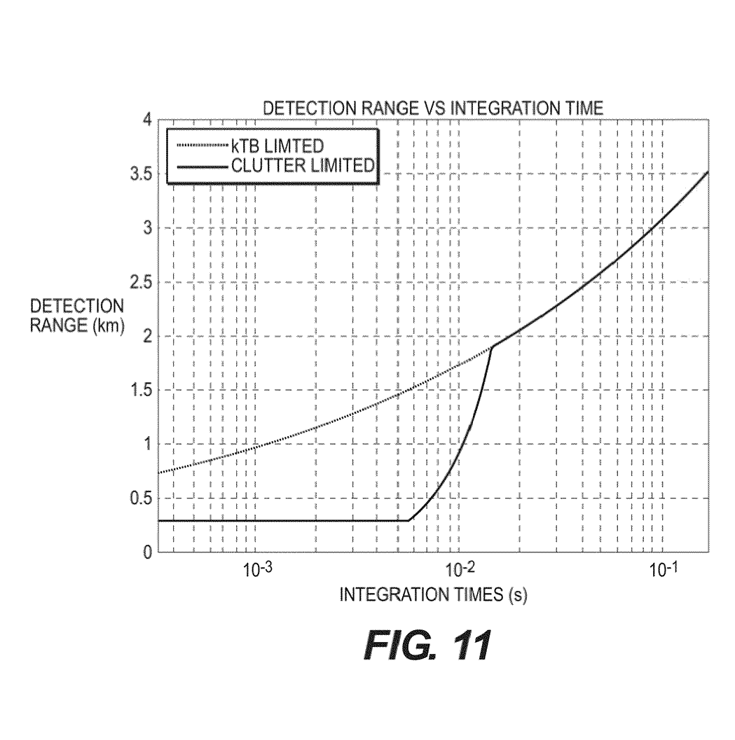

A plot of a first cut analysis for the detection range of the pulse Doppler MIMO of FIG. 10 is shown in FIG. 11. The analysis was performed based on the following parameters and conditions:

| Radar Parameters | Conditions |
|---|---|
| PRF = 150 kHz | Ground reflectivity, γ = 0.1 |
| Pulse duration = 1.67 msec | Height = 300 m |
| Mean power = 1 Watt | 300 m/sec relative closing velocity |
| Wavelength = 3 cm. | 10 dB single-look detection threshold |
| Intrinsic range res. = 250 m | |

Again it can be readily seen that the array remains virtually clutter free until R=300 m.

As briefly mentioned above linear array shown in FIGS. 2 and 3 of the system of the present invention, may also find application in a missile approach warning application which is in essence a special case scenario of the collision avoidance system. Such approach warning system could for example employ 3 arrays per the configuration detailed in FIGS. 2 and 3. Based on the information received from all 3 arrays the system can then calculate the exact bearing, altitude and velocity of an incoming target and compute appropriate course corrections to avoid the incoming missile.

FIG. 12 depicts one possible arrangement of a radar pod 1200 according to one embodiment of the present invention. The pod 1200 in this example forms the 32 beams with four transmitters and eight receivers for each linear array housed in the pod 1200. The pod 1200 in this instance is of a square cross section and includes a plurality of radiating slots 1201a₁, 1201a₂, 1201a₃, 1201a₄ and a plurality of receiving slots 1202a₁, 1202a₂, 1202a₃, 1202₄, 1202a₅, 1202a₆, 1202a₇, 1202a₈ disposed along surface 1203a. Likewise a plurality of radiating slots 1201b₁, 1201b₂, 1201b₃, 1201b₄ and a plurality of receiving slots 1202b₁, 1202b₂, 1202b₃, 1202b₄, 1202b₅, 1202b₆, 1202b₇, 1202b₈ disposed along surface 1203b. Similar arrangements are also disposed along the remaining surfaces 1203c and 1203d of the pod 1200. It will be appreciated by those of ordinary skill in the art that the pod 1200 need not be of square cross section, the pod could have a circular, triangular, rectangular, octagonal, hexagonal cross section or any other such suitable closed planar shape.

The pod 1200 in this instance houses the RF front end of the system. An umbilical tethers the RF front end to the signal capture and processing modules situated within the fuselage of the UAV. The RF front end in this case is constructed from four linear antenna arrays 1204a, 1204b, 1204c, 1204d. FIG. 13 shows the construction of one of the arrays 1204a which supports a plurality of patch elements 1205a₁, 1205a₂, 1205a₃, 1205a₄, 1205a₅. The patch elements 1205a₁, 1205a₂, 1205a₃, 1205a₄, 1205a₅ in this case are constructed as half wavelength slots disposed on a conductive surface. Each element 1205a₁, 1205a₂, 1205a₃, 1205a₄, 1205a₅ is coupled to a feed element 1206a₁, 1206a₂, 1206a₃, 1206a₄, 1206a₅ and grounded along one edge so as to provide 180° cover. Each of the arrays 1204a, 1204b, 1204c, 1204d are then mounted within the pod such that the respective transmitting and receiving elements align with the radiating and receiving slots 1201a₁, 1201a₂, 1201a₃, 1201a₄, 1202a₂, 1202a₃, 1202a₄, 1202a₅, 1202a₆, 1202a₇, 1202a₈ disposed along the outer surfaces 1203a, 1203b, 1203c and 1203d of the pod 1200.

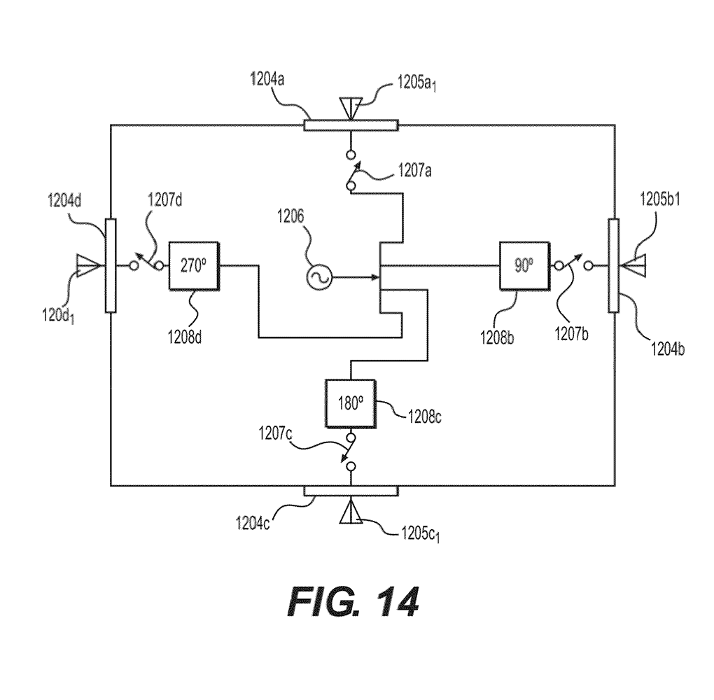

The four linear arrays are linked to form a turnstile arrangement. An example of the feed network for one of the transmitter arrays of the turnstile arrangement is shown in FIG. 14. Here patch elements 1205a₁, 1205b₁, 1205c₁, 1205d₁ from each of the four arrays 1204a, 1204b, 1204c, 1204d are configured as active transmitter elements. Each of the patch elements 1205a₁, 1205b₁, 1205c₁, 1205d₁ being coupled via switches 1207a, 1207b, 1207c, 1207d to a signal source 1206. A phase shift is applied to the transmission signal supplied to each of the transmitters 1205b₁, 1205c₁, 1205d₁ via phase shifters 1208b, 1208c, 1208d. Phase shifter 1208b in this instance applies a phase shift of 90° to the signal supplied to transmitter 1205b₁, while phase shifters 1208c and 1208d apply phase shifts of 180° and 270° respectively to the signal supplied to transmitters 1205c₁, 1205d₁ respectively. Thus in the present example the four transmitter elements of the array are phased in quadurature.

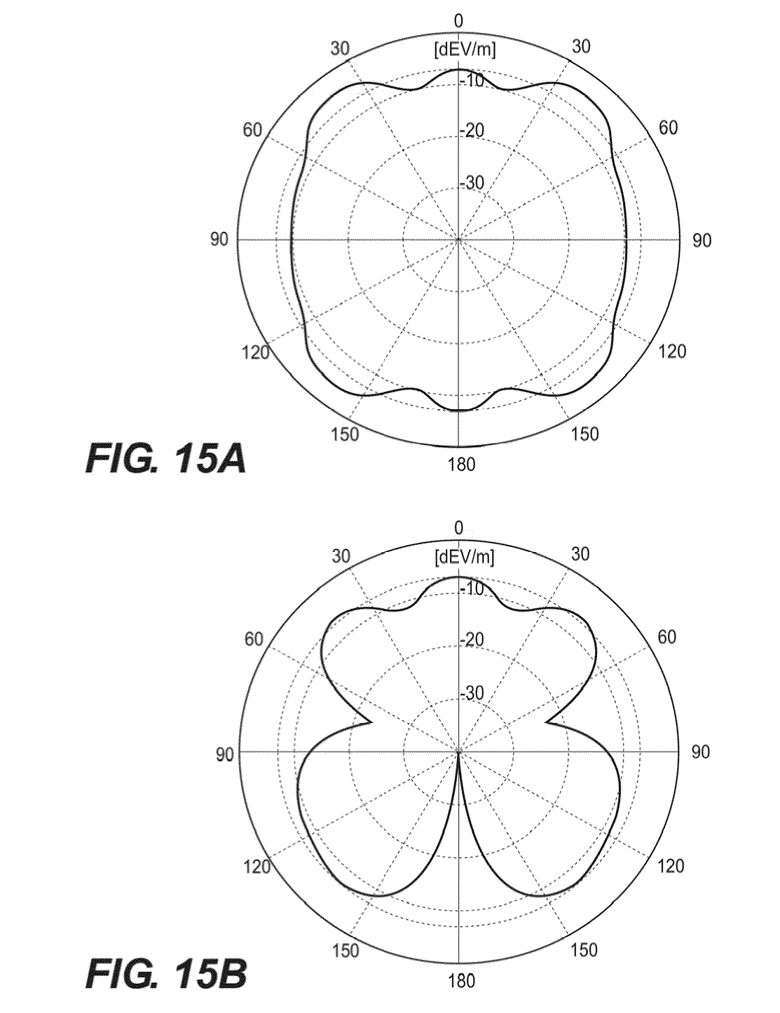

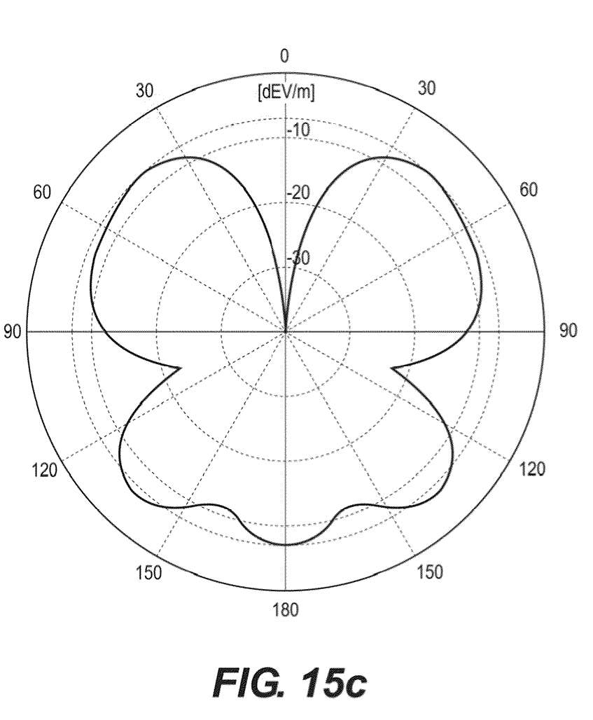

Phasing the transmitter elements in quadrature enables the turnstile arrangement to provide full spherical cover albeit with circular polarisation in the end fire direction and along the central axis of the pod. In the plane normal to the pod the turnstile arrangement produces a linear polarisation. Polar plots of the radiation pattern produced by the pod 1200, utilising the turnstile arrangement, in the plane normal to the turnstile arrangement are shown in FIGS. 15A-15C. As shown in FIG. 15A the total field produced by the four elements fed in phase quadrature of the turnstile arrangement provides near spherical cover. FIGS. 15B and 15C show the radiation pattern in the fore and aft end fire directions as shown 15B exhibits left circular polarisation while the pattern shown in FIG. 15C exhibits right circular polarisation.

One advantage to the turnstile arrangement is that it allows the system to readily switch between two modes of operation a search mode and a track mode. In search mode the radar detects targets out of surrounding clutter. In this mode the antenna array is configured to give near all-round cover and good visibility against ground clutter. If a collision threat is detected it is desirable to know the angle of arrival of the threat allowing the selection of a preferred manoeuvre to obtain this the system then switches to the track mode.

In track mode the antenna array is reconfigured to determine the relative position of the threat to determine whether the detected target is on a collision course. This is done by switching in turn between the four transmitters on each turnstile arrangement on sequential pulses. The system then determines potential collision paths on the basis of Doppler and relative bearing which are monitored as a function of range. A constant relative bearing and a constant closing Doppler gives an indication of a collision threat. If such a collision threat is detected the system signals the flight dynamics layer (which is discussed in greater detail below) to effect the necessary action.

In order to identify a threat the system must firstly produce a Range/Doppler map from all of the 32 beams, or at least those covering more than the defined cockpit field of view of +/−120 degrees. In this particular application the upper Doppler frequency is set by the maximum allowed aircraft velocities corresponding to a maximum closing velocity of 200 m/s at altitudes below 10,000 ft. The exact range within which a target must be detected depends on a combination of factors including the time required by the system to make a decision and then the time required to complete evasive action.

Measuring both range and Doppler at X-Band requires a trade-off between range and Doppler cover. The waveforms capable of obtaining a non-ambiguous Doppler measure at velocities of up to 200 m/s effectively reduce the unambiguous range of the system down to about 2 km. In addition to the Range/Doppler requirement the transmitter waveforms must meet the requirements for MIMO processing in order to separate the received signals from each of the transmitters. Moreover the waveform used to produce the map must range compress to give the required range resolution with minimal or zero range sidelobes. The range compression process must also minimise leakage of signals between channels. Furthermore any blind zones caused by transmitter pulses blocking receivers must be manageable. In particular the blind zones should not obscure nearby targets, however intermittent blind zones at narrow range bands are acceptable.

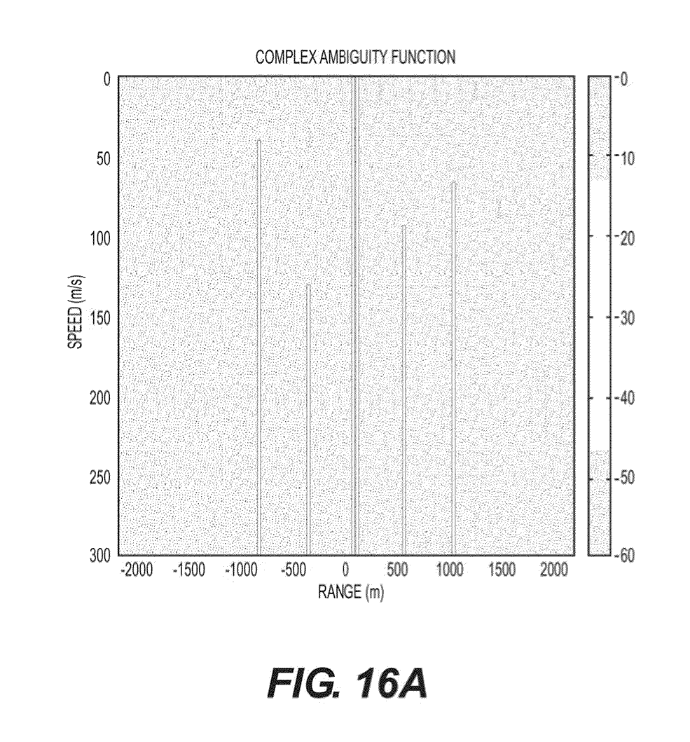

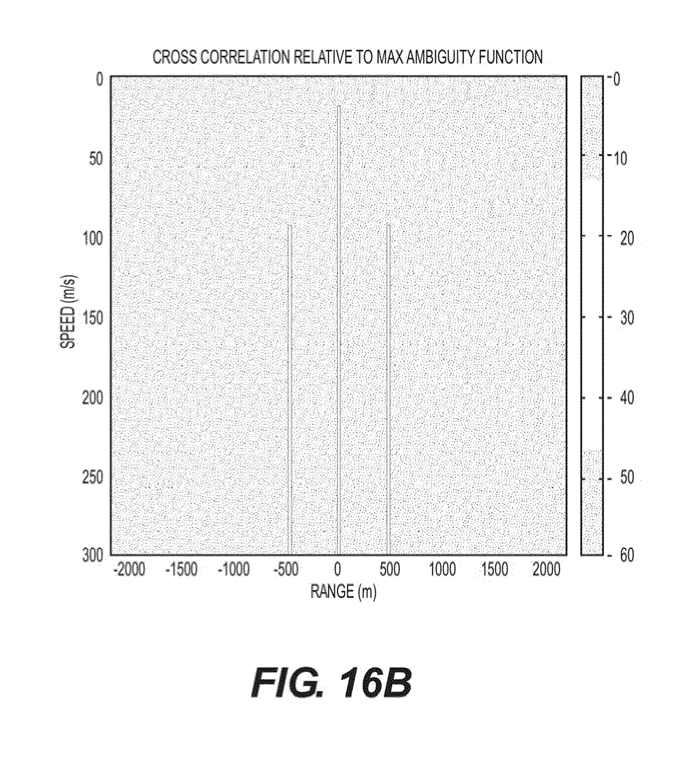

In light of the above constraints the applicant has devised a set code sequences based on the waveforms proposed Suchiro, N. and Hatori, M., “N-Shift Cross-Orthogonal Sequences”, IEEE Trans. Information Theory, Vol. 34, p. 143-146, January 1988. Under the coding regime proposed by the applicant, each of the four transmitters sends a sequence of four code burst, sufficiently spaced to allow for reception of all the return signals from the burst out to a range of 2 km. The data from each burst is then range compressed by correlation. After the four bursts have been range compressed they are then summed. Both the range sidelobes and cross code leakage are cancelled as shown in FIGS. 16A and 16B. Exact cancellation only occurs at zero Doppler, but as FIGS. 16A and 16B demonstrate, the extent to which the range sidelobes and cross channel leakage is contaminated by Doppler is limited to 300 m/s.

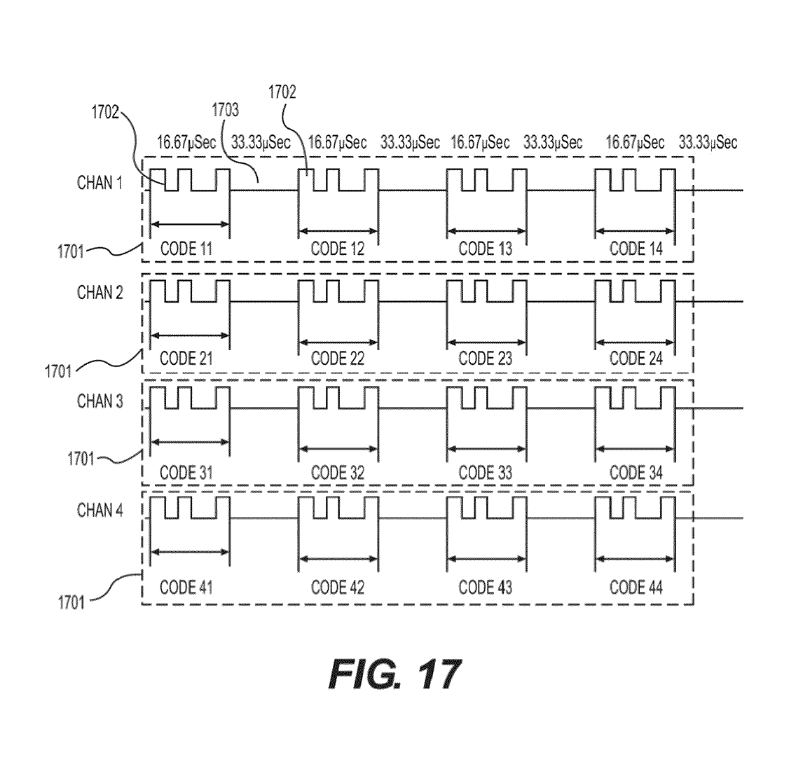

In order to minimise the impact of large targets at ambiguous ranges, a pulse interval jitter scheme is employed. The codes 1701 are transmitted one chip 1702 at a time and the returns from each chip are collected 1703 before transmitting the next chip 1702. This allows the code sequence to work with close-in targets. In effect the sequences are spread in time to spread the blind zone from the nearby region to a set of disconnected smaller zones up to 1 km. The timing diagram for a proposed X Band system is shown in FIG. 17.

To determine the proposed system's ability to detect targets within clutter, an analysis for three well accepted land clutter models, i.e. “Farmland”, “Rolling Hills” and “Mountains” was performed by modelling the array pattern geometry and computing clutter returns based on the three identified clutter models. The clutter radar cross-section model used for the analysis was similar to that utilised in J. F. Roulston, “Clutter models for pulse Doppler”, Radar Tutorial Course, Module 6, Scimus Solutions Ltd., March 2007. Range/Doppler clutter maps were initially computed for an omni-directional antenna at differing altitudes, using 6 m range cells and 34 Hz Doppler cells (0.5 m/s at X band), including antenna gain. The antenna array factors were then imposed on the clutter maps for the omni-directional array factors, based on the entire set of beams.

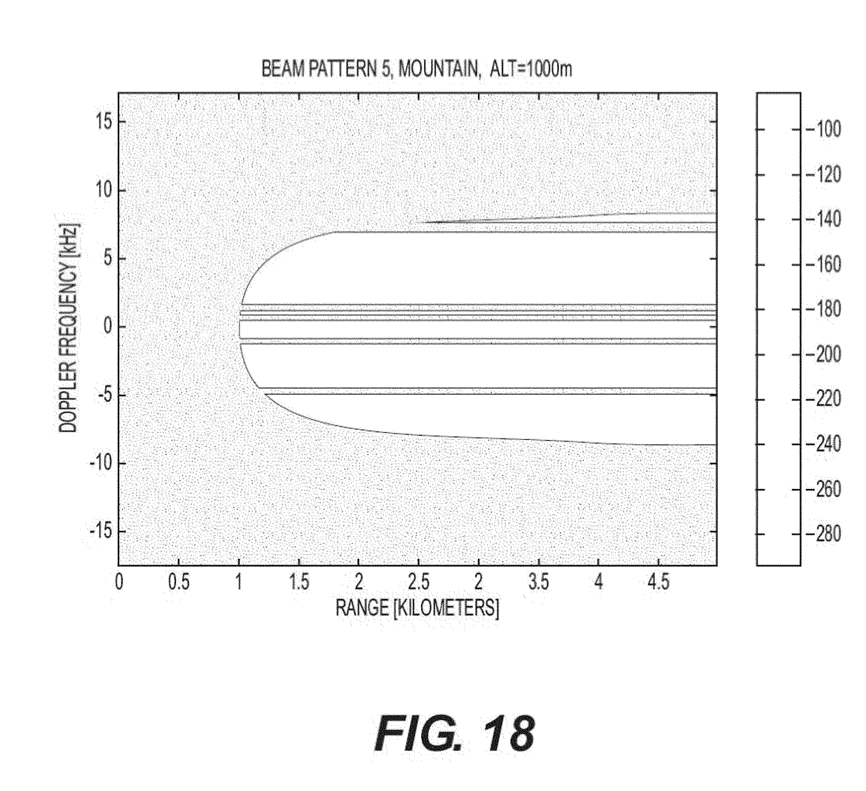

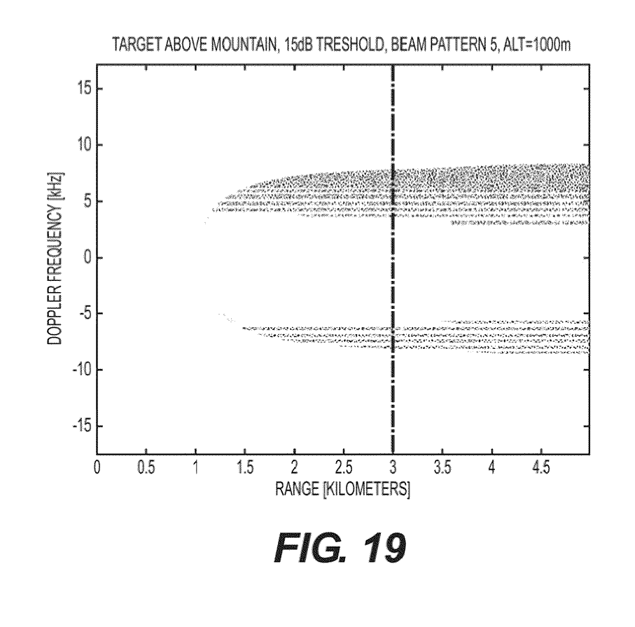

FIG. 18 shows an example beam clutter map for the “Mountains” model representing the worst case model. The ground main-beam clutter as illustrated is retained in a narrow spectrum at all ranges. The Range/Doppler maps of the target were then computed and combined with the Range/Doppler maps of the clutter. Finally, 15 dB detection thresholds were applied to the signal-to-clutter maps to delineate the regions where targets are lost. FIG. 19 shows the resulting map for a 5 m² target in the region 60° from broadside beam for an altitude of 1000 m. The dark areas indicate where the clutter is likely to obscure the target, while the vertical line shows the 3 km range. It can be seen that most of the clutter masking occurs beyond the range of interest.

The analysis of the signal-to clutter maps shows that collision risks can be detected in clutter for all velocities in a given beam except those immediately adjacent to the ground. That is, only near stationary targets are lost. These targets present a lower collision risk. Moreover, they will become visible once they were within the altitude range, i.e. in the absence of ground clutter effects.

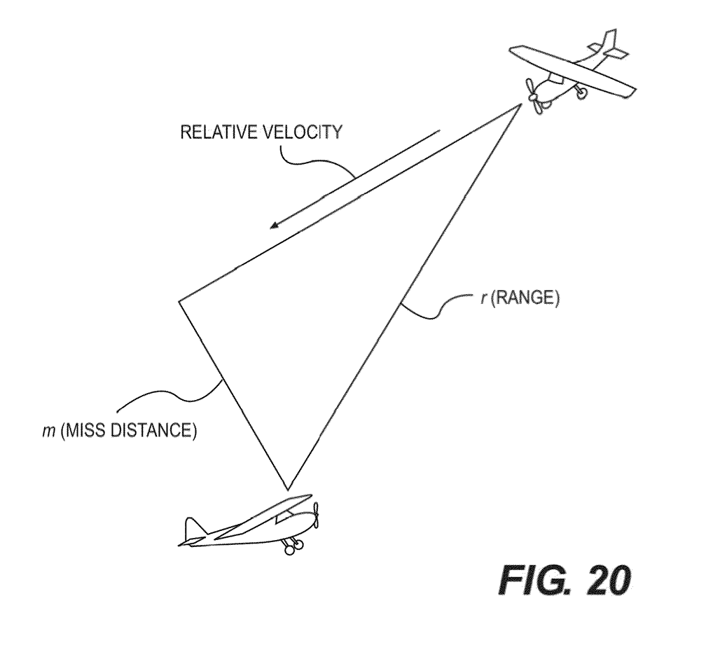

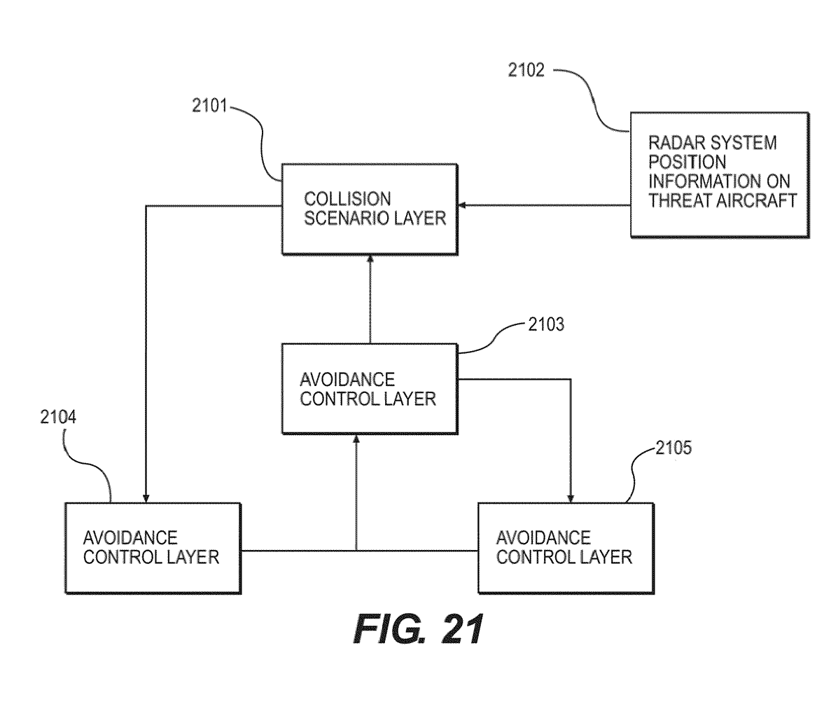

The algorithm used to determine whether or not a detected target constitutes a collision threat is based on the relationship between the miss distance, range, and range rate for a typical near-collision scenario, as illustrated in FIG. 20. Assuming velocities remain constant throughout the detection scenario, it is clear that at any given time, the range rate \dot{r} can be expressed as a function of range r, miss distance m, and relative velocity (vrel):

$$\dot{r} = vrel \frac{\sqrt{{r}^{2} - {m}^{2}}}{r} \qquad ( 1 )$$

Using the relationship in equation (1), a comparison of the simulated range rate with that expected from a target on a miss distance of 177.4 m corresponding to the definition of a Near Mid-Air Collision (NMAC) of 500 feet plus a 25 m safety buffer FAA, “Aeronautical Information Manual” Chapter 7, Section 6, Paragraph 7-6-3(b), 2007 was performed. Doppler signals modelled on (1) were added to thermal noise to give a signal to noise ratio of 15 dB at the FFT output as specified for the maximum detection range of the radar. The range and range rate estimates used for the comparisons were passed through an alpha-beta filter to reduce the system's vulnerability to intermittent measurement errors and missed detections. Difference values obtained from the range rate comparisons were then tracked over time using an IIR filter, which places a stronger weighing towards more recent trends. The comparison of these difference values with the difference values expected from a target on course for a miss distance of 177.4 m provides a collision warning.

A rudimentary collision avoidance algorithm was then developed based on the azimuth of the incoming target. For near head-on scenarios, a turn is initiated towards the right, in compliance with rules of the air. Similarly, for targets approaching from the rear, a turn is initiated to the left. This is done in case the target aircraft also detects the host aircraft (which will appear in the head-on position) and makes a corresponding turn to the right. The commanded actions for other approach angles are listed in the Table I below:

TABLE I
List of Avoidance Manoeuvres vs. Target Direction

| Direction of Target | |
|---|---|
| (Clockwise angle from | Change to Current |
| longitudinal axis) | Heading |
| 337.5°-22.5° | 90° |
| (Near-Head-On) | |
| 22.5°-67.5° | 90° |
| 67.5°-112.5° | 190° |
| 112.5°-157.5° | 225° |
| 157.5°-202.5° | 270° |
| 202.5°-247.5° | 135° |
| 247.5°-292.5° | 170° |
| 292.5°-337.5° | 270° |

A complete simulation model of the collision avoidance process, is outlined in FIG. 21. As shown the collision scenario layer 2101 receives information from the radar system 2102 on the position and azimuth of the inbound target and information from the flight dynamics layer 2103, as to the current position bearing and speed of the host aircraft. The collision scenario layer 2101 then determines which collision scenario the inbound target falls into as summarised in Table I above. As soon as the collision scenario layer 2101 has determined which collision scenario the target fall into it advises the avoidance control layer 2104. The avoidance control layer 2104 then plots any necessary course alterations and then relays the new course data to the flight dynamics layer 2103. The flight dynamics layer 2103, then advises the flight control layer 2105 of the necessary course changes. The flight control layer 2105 then alters the aircraft bearing and speed as required and relays the change in flight status back to flight dynamic layer 2103, which in turn relays the current heading information to the collision scenario layer 2101. This process is repeated until the aircraft has determined that no collision threat exists.

An extensive campaign of simulation and testing has demonstrated the viability of the proposed radar system for use in a UAV sense and avoid application. Perhaps most significantly of all, the present results demonstrate that a separation distance of 500 feet may be achieved across the entire spectrum of simulated collision scenarios, which featured a wide range of altitudes, collision angles and closing velocities.

Additionally, the measurement accuracy provided by the radar model was proved to be sufficient, in that for the vast majority of cases it allowed the system to correctly discriminate between target aircraft on a near mid-air collision course and those passing at a marginally safe distance. However, it was established that detection performance was weaker in scenarios featuring particularly low closing velocities, since quantisation error and measurement noise make the small changes in range rate difficult to track. This may be rectified by placing a higher threshold for detection on these scenarios, taking advantage of the fact that there is some excess time available in which to avoid potential collisions.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1. A collision avoidance system for an unmanned vehicle, comprising:
a plurality of transmitter elements;
a plurality of receiver elements for receiving a plurality of return signals from one or more objects within range of said unmanned vehicle; and
at least one processor coupled to the transmitter and receiver elements, said processor being adapted to:
transmit form said plurality of transmitters a set of pulses about the unmanned vehicle;
generate from said return signals a plurality of conical beams covering a volume of interest about the vehicle;
analyze one or more signals within the plurality of conical beams to determine if one or more objects within range of the unmanned vehicle are on a collision path; and
alter the course of the unmanned vehicle upon determining that at least one object of the one or more objects is on a collision path with said unmanned vehicle.

2. The collision avoidance system of claim 1, wherein the pulses each have a different signature code.

3. The collision avoidance system of claim 2, wherein each signature code is a carrier frequency selected from a set of predetermined frequencies.

4. The collision avoidance system of claim 1, wherein the transmitter elements transmit the plurality of pulses utilizing time division multiplexing (TDM), wherein successive pulses are transmitted at a time delay of sufficient length to allow the receiving elements to separate out return signals for each transmitting element reflected by one or more objects within range.

5. The collision avoidance system of claim 1, wherein the transmitter elements transmit the plurality of pulses utilizing a code division multiplexing scheme, whereby each transmitter element simultaneously transmits a coded pulse of the same frequency allowing the receiving elements to separate out return signals associated which each transmitter element reflected by one or more objects within range.

6. The collision avoidance system of claim 2, wherein the transmitter elements transmit the plurality of pulses in accordance with a frequency division multiplexing (FDM) scheme, wherein each signature code is formed from a sequence of carrier frequencies selected from a set of predetermined frequencies allowing the receiving elements to separate out return signals for each transmitting element reflected by one or more objects within range.

7. The collision avoidance system of claim 6, wherein the carrier frequencies of the pulses are cycled incrementally after each transmission, such that each transmitter element transmits a full set of pulses covering all the predetermined frequencies.

8. The collision avoidance system of claim 7, wherein the transmission of the pulses is staggered, whereby each transmitter element transmits a different carrier frequency within the sequence of pulses to that of an adjacent transmitter element.

9. The collision avoidance system of claim 8, wherein a number of frequency steps L is equal to or greater than number of transmitter elements N, and wherein the receiver elements are arranged such that each receiver element captures L×M sequences, where M is the number of receiver elements.

10. The collision avoidance system of claim 6, wherein a constant frequency separation is maintained between the carrier frequencies of each pulse, or wherein pulse compression is employed.

11. The collision avoidance system of claim 1, wherein:
the pulses are transmitted in accordance with an orthogonal frequency division multiplexing (OFDM) scheme;
the transmitter and receiver elements comprise dipole antennas configured to operate in the L, S, C, X, Kᵤ, K or Kₐ bands; or
the processor is coupled to the transmitter and receiver elements via a plurality of multiplexers.

12. A collision avoidance system for an unmanned vehicle, comprising:
a plurality of antenna elements arranged parallel to a longitudinal axis of the unmanned vehicle;
at least one processor coupled to the plurality antenna elements, said processor being adapted to:
transmit from one or more antenna elements, of said plurality of antenna elements, a set of pulses in wide angles about the unmanned vehicle;
generate a plurality of conical beams covering a volume of interest about the unmanned vehicle from a plurality of return signals received by the remaining antenna elements from one or more objects within range of the unmanned vehicle;
analyze one or more signals within the plurality of conical beams to determine if one or more objects within range of the unmanned vehicle are on a collision path; and
alter the course of the unmanned vehicle on determining that at least one object of the one or more objects is on a collision path with said unmanned vehicle.

13. The collision avoidance system of claim 12, wherein the antenna elements are arranged as paired linear arrays, wherein the paired arrays are disposed orthogonal to each other and mounted parallel to the longitudinal axis of the unmanned vehicle.

14. The collision avoidance system of claim 13, wherein:
each linear array includes at least two transmitter elements, each of said at least two transmitter elements being phased in quadrature such that opposing transmitter elements in the paired arrays are 180° out of phase; or
each linear array includes at least two transmitter elements, each of said at least two transmitter elements being phased in quadrature such that adjacent transmitter elements are 90° out of phase.

15. A method of avoiding a collision for an unmanned vehicle, the method comprising:
transmitting, from a plurality of transmitter elements, a plurality of pulses about the unmanned vehicle;
receiving by a plurality of receiver elements a plurality of return signals from one or more objects in range of the unmanned vehicle;
generating from said return signals a plurality of conical beams covering a volume of interest about the unmanned vehicle;
analyzing one or more signals within the plurality of conical beams to determine if one or more objects within range of the unmanned vehicle are on a collision path; and
altering the course of the unmanned vehicle upon determining that at least one object of the one or more objects is on a collision path with said unmanned vehicle.

16. The method of claim 15, wherein the pulses each have a different signature code.

17. The method of claim 15, wherein the transmitting the plurality of pulses comprises:
utilizing time division multiplexing (TDM), wherein successive pulses are transmitted at a time delay of sufficient length to allow the receiving elements to separate out return signals for each transmitting element reflected by one or more objects within range; or
utilizing a code division multiplexing scheme, whereby each transmitter simultaneously transmits a differently coded pulse of the same frequency allowing the receiving elements to separate out return signals for each transmitting element reflected by one or more objects within range.

18. The method of claim 16, wherein the plurality of pulses are transmitted in accordance with a frequency division multiplexing (FDM) scheme, wherein each signature code is formed from a sequence of carrier frequencies selected from a set of predetermined frequencies allowing the receiving elements to separate out return signals for each transmitting element reflected by one or more objects within range.

19. The method of claim 18, further comprising:
incrementally cycling the carrier frequencies of the pulses after each transmission, such that each transmitter element transmits a full set of pulses covering all the predetermined frequencies.

20. The method of claim 16, wherein:
each signature code comprises a carrier frequency selected from a set of predetermined frequencies;
the conical pulse are transmitted in accordance with an orthogonal frequency division multiplexing (OFDM) scheme;
the transmission of the pulses is staggered, whereby each transmitter element transmits a different carrier frequency within the sequence of pulses to that of an adjacent transmitter element;
a number of frequency steps L is equal to or greater than number of transmitter elements N, and the receiver elements are arranged such that each receiver element captures L×M sequences, where M is the number of receiver elements;
a constant frequency separation is maintained between the carrier frequencies of each pulse;
pulse compression is employed;
the transmitter and receiver elements are cross-polarised dipoles configured to operate in the L, S, C, X, Kᵤ, K or Kₐ bands; or
antenna elements are arranged as paired linear arrays, wherein the paired arrays are disposed orthogonal to each other and mounted parallel to the longitudinal axis of the unmanned vehicle, and wherein each linear array includes at least one transmitter element, each of said at least one transmitter elements are phased in quadrature such that opposing transmitter elements in the paired arrays are 180° out of phase, or adjacent transmitter elements are 90° out of phase.
